(19) United States
(12) Patent Application Publication
(10) Pub. No.: US 2026/0052234 A1
(43) Pub. Date: Feb. 19, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zhipin DENG, Beijing (CN); Kai Zhang, Los Angeles, CA (US); Li Zhang, Los Angeles, CA (US)

(21) Appl. No.: 19/367,697

(22) Filed: Oct. 23, 2025

Related U.S. Application Data
(63) Continuation of application No. PCT/CN2024/089219, filed on Apr. 22, 2024.

(30) Foreign Application Priority Data
Apr. 23, 2023 (WO) PCT/CN2023/090137

(51) Int. Cl. H04N 19/105; H04N 19/159; H04N 19/176; H04N 19/186; H04N 19/96

(52) U.S. Cl. CPC H04N 19/105; H04N 19/159; H04N 19/176; H04N 19/186; H04N 19/96

(57) ABSTRACT

Embodiments of the disclosure provide a solution for video processing. A method for video processing is proposed. The method includes: determining, for a conversion between a video unit of a video and a bitstream of the video, a set of training samples for a cross-component prediction (CCP) model generation for a chroma block based on at least one of: a prediction mode of at least one luma sample, a block vector, a motion vector, a reference block identified by the block vector, or a reference block identified by the motion vector; deriving a CCP model based on the set of training sample; and performing the conversion based on the CCP model.

### CROSS-REFERENCE TO RELATED APPLICATIONS

This application is a continuation of International Application No. PCT/CN2024/089219, filed on Apr. 22, 2024, which claims the benefit of International Application No. PCT/CN2023/090137 filed on Apr. 23, 2023. The entire contents of these applications are hereby incorporated by reference in their entireties.

### FIELDS

Embodiments of the present disclosure relates generally to video processing techniques, and more particularly, to motion vector dependent cross component prediction (CCP) model.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, there are several issues in conventional video coding, which is undesirable. Therefore, the coding gain of conventional video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, a set of training samples for a cross-component prediction (CCP) model generation for a chroma block based on at least one of: a prediction mode of at least one luma sample, a block vector, a motion vector, a reference block identified by the block vector, or a reference block identified by the motion vector; deriving a CCP model based on the set of training sample; and performing the conversion based on the CCP model. Compared with the conventional solution, the method in accordance with the first aspect of the present disclosure can derive a CCP model differently to achieve higher coding efficiency.

In a second aspect, another method for video processing is proposed. The method comprises: determining, for a conversion between a video unit of a video and a bitstream of the video, that a direct block vector (DBV) mode is used in at least one of: an inter slice, a single tree, or camera captured video content; and performing the conversion based on the DBV mode. Compared with the conventional solution, the method in accordance with the second aspect of the present disclosure can advantageously improve the coding efficiency and performance by allowing DBV mode not only in intra dual tree slice.

In a third aspect, an apparatus for video processing is proposed. The apparatus comprises a processor and a non-transitory memory with instructions thereon. The instructions upon execution by the processor, cause the processor to perform a method in accordance with the first, or second aspect of the present disclosure.

In a fourth aspect, a non-transitory computer-readable storage medium is proposed. The non-transitory computer-readable storage medium stores instructions that cause a processor to perform a method in accordance with the first, or second aspect of the present disclosure.

In a fifth aspect, another non-transitory computer-readable recording medium is proposed. The non-transitory computer-readable recording medium stores a bitstream of a video which is generated by a method performed by an apparatus for video processing. The method comprises: determining a set of training samples for a cross-component prediction (CCP) model generation for a chroma block based on at least one of: a prediction mode of at least one luma sample, a block vector, a motion vector, a reference block identified by the block vector, or a reference block identified by the motion vector; deriving a CCP model based on the set of training sample; and generating the bitstream based on the CCP model.

In a sixth aspect, a method for storing a bitstream of a video is proposed. The method comprises: determining a set of training samples for a cross-component prediction (CCP) model generation for a chroma block based on at least one of: a prediction mode of at least one luma sample, a block vector, a motion vector, a reference block identified by the block vector, or a reference block identified by the motion vector; deriving a CCP model based on the set of training sample; generating the bitstream based on the CCP model; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by an apparatus for video processing. The method comprises: determining, that a DBV mode is used in at least one of: an inter slice, a single tree, or camera captured video content; and generating the bitstream based on the DBV mode.

In an eighth aspect, a method for storing a bitstream of a video is proposed. The method comprises: determining, that a DBV mode is used in at least one of: an inter slice, a single tree, or camera captured video content; generating the bitstream based on the DBV mode; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an illustration of the effect of the slope adjustment parameter “u” where model created with the current CCLM is shown on the left and model updated as proposed is shown on the right;

FIG. 5 illustrates neighboring blocks (L, A, BL, AR, AL) used in the derivation of a general MPM list;

FIG. 6 illustrates neighboring reconstructed samples used for DIMD chroma mode;

FIG. 7 illustrates intra template matching search area used;

FIG. 8 illustrates the use of IntraTMP block vector for IBC block;

FIG. 9 illustrates the division method for angular modes;

FIG. 10 illustrates extended MRL candidate list;

FIG. 11 illustrates an illustration of the template area;

FIG. 12 illustrates spatial part of the convolutional filter;

FIG. 13 illustrates reference area (with its paddings) used to derive the filter coefficients;

FIG. 14 illustrates four Sobel based gradient patterns for GLM;

FIG. 15 illustrates spatial GPM candidates;

FIG. 16 illustrates an GPM template;

FIG. 17 illustrates an GPM blending;

FIG. 18 illustrates possible positions of candidate regions;

FIG. 19 illustrates positions of the adjacent spatial candidates;

FIG. 20 illustrates a transform selection process for directional planar modes;

FIG. 21 illustrates luma blocks used to derive direct block vector;

FIG. 22 illustrates the proposed method on the decoder;

FIG. 23 illustrates luma samples L0, . . . , L5 in relation to the chroma sample C (shown in a half-pel luma grid);

FIG. 24 illustrates a flowchart of a method for video processing in accordance with embodiments of the present disclosure;

FIG. 25 illustrates a flowchart of a method for video processing in accordance with embodiments of the present disclosure; and

FIG. 26 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

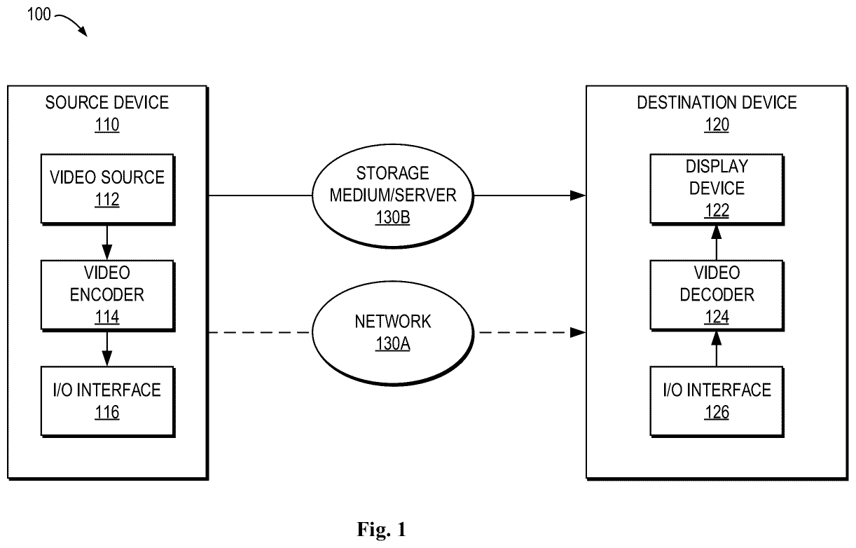

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

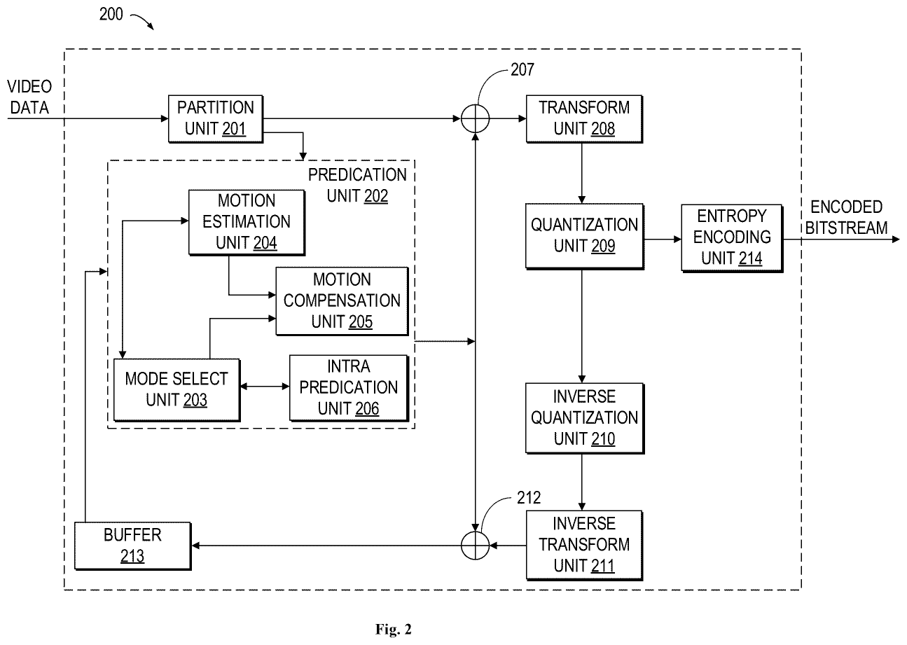

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

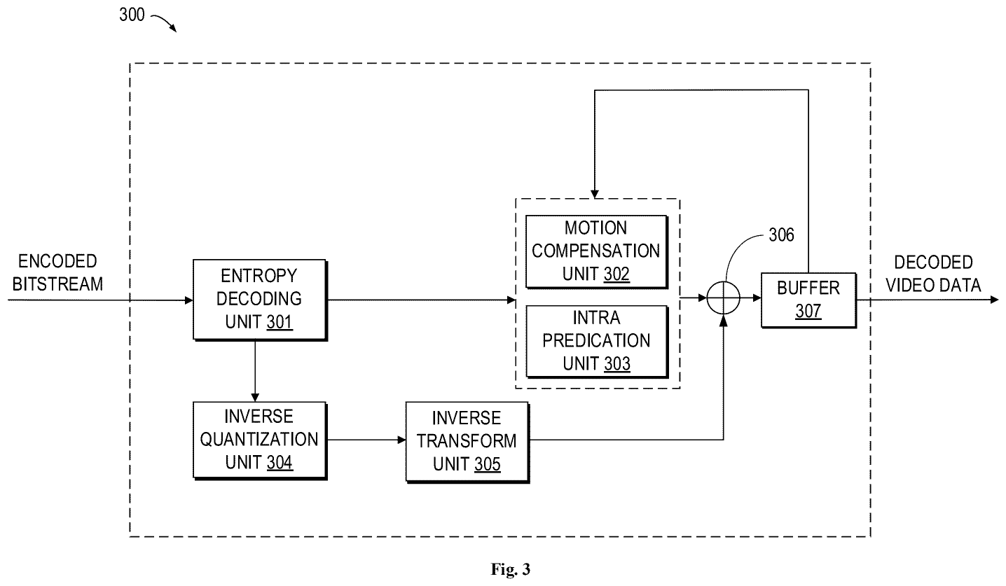

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter.

It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1 Brief Summary

The present disclosure is related to video coding technologies. Specifically, it is about chroma prediction in image/video coding. It may be applied to the existing video coding standard like HEVC, VVC, and etc. It may be also applicable to future video coding standards or video codec.

### 2 Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The NET meeting is concurrently held once every quarter, and the new video coding standard was officially named as Versatile Video Coding (VVC) in the April 2018 NET meeting, and the first version of VVC test model (VTM) was released at that time. The VVC working draft and test model VTM are then updated after every meeting. The VVC project achieved technical completion (FDIS) at the July 2020 meeting.

### 2.1 Intra Prediction

In intra prediction the smallest chroma intra prediction unit (SCIPU) constraint in VVC is removed. In addition, the VPDU constraint for reducing CCLM prediction latency is also removed.

### 2.1.1 Multi-Model LM (MMLM)

CCLM included in VVC is extended by adding three Multi-model LM (MMLM) modes. In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.

### 2.1.1.1 Slope Adjustment of CCLM

CCLM uses a model with 2 parameters to map luma values to chroma values. The slope parameter “a” and the bias parameter “b” define the mapping as follows:

$$chromaVal = a * lumaVal + b$$

An adjustment “u” to the slope parameter is signaled to update the model to the following form:

$$chromaVal = {a}^{′} * lumaVal + {b}^{′}$$

$$where$$

$${a}^{′} = a + u$$

$${b}^{′} = b - u * {y}_{r} .$$

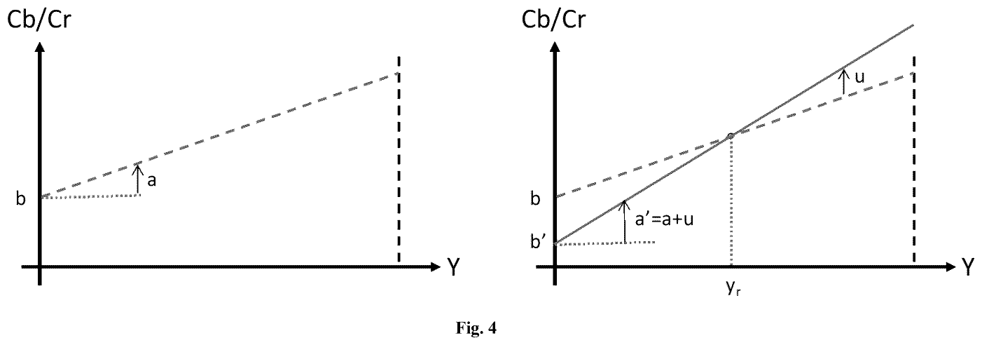

With this selection the mapping function is tilted or rotated around the point with luminance value yᵣ. The average of the reference luma samples used in the model creation as yᵣ in order to provide a meaningful modification to the model. Picture below illustrates the process.
FIG. 4 illustrates the effect of the slope adjustment parameter “u”. Left: model created with the current CCLM. Right: model updated as proposed.

### Implementation

Slope adjustment parameter is provided as an integer between −4 and 4, inclusive, and signaled in the bitstream. The unit of the slope adjustment parameter is ⅛^{th} of a chroma sample value per one luma sample value (for 10-bit content).
Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.
When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### 2.1.2 Gradient PDPC

In VVC, for a few scenarios, PDPC may not be applied due to the unavailability of the secondary reference samples. In these cases, a gradient based PDPC, extended from horizontal/vertical mode, is applied. The PDPC weights (wT/wL) and nScale parameter for determining the decay in PDPC weights with respect to the distance from left/top boundary are set equal to corresponding parameters in horizontal/vertical mode, respectively. When the secondary reference sample is at a fractional sample position, bilinear interpolation is applied.

### 2.1.3 Secondary MPM

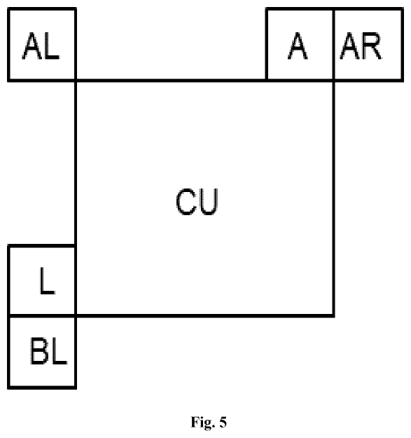

Secondary MPM lists is introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks, the directional modes with added offset from the first two available directional modes of neighbouring blocks, and the default modes.
If a CU block is vertically oriented, the order of neighbouring blocks is A, L, BL, AR, AL; otherwise, it is L, A, BL, AR, AL. FIG. 5 illustrates neighbouring blocks (L, A, BL, AR, AL) used in the derivation of a general MPM list.
A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.1.4 Reference Sample Interpolation and Smoothing for Intra-Prediction

The 4-tap cubic interpolation is replaced with a 6-tap cubic interpolation filter, for the derivation of predicted samples from the reference samples.
For reference sample filtering, a 6-tap gaussian filter is applied for larger blocks (W>=32 and H>=32), existing VVC 4-tap gaussian interpolation filter is applied otherwise. The extended intra reference samples are derived using the 4-tap interpolation filter instead of the nearest neighbor rounding.

### 2.1.5 Decoder Side Intra Mode Derivation (DIMD)

When DIMD is applied, two intra modes are derived from the reconstructed neighbor samples, and those two predictors are combined with the planar mode predictor with the weights derived from the gradients. The division operations in weight derivation are performed utilizing the same lookup table (LUT) based integerization scheme used by the CCLM. For example, the division operation in the orientation calculation

$$Orient = {G}_{y} / {G}_{x}$$

is computed by the following LUT-based scheme:

$$x = Floor ( Log 2 ( Gx ) )$$

$$normDiff = ( ( Gx ≪ 4 ) ≫ x ) \& 15$$

$$x += ( 3 + ( normDiff != 0 ) ? 1 : 0 )$$

$$Orient = ( Gy * ( DivSigTable [ normDiff ] \vert 8 ) + ( 1 ≪ ( x - 1 ) ) ) ≫ x$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

### 2.1.5.1 DIMD Chroma Mode

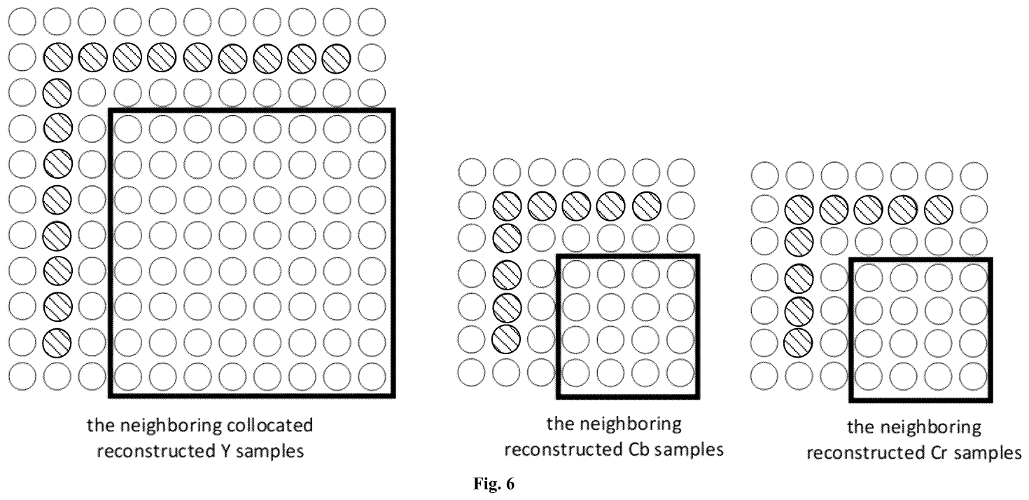

The DIMD chroma mode uses the DIMD derivation method to derive the chroma intra prediction mode of the current block based on the neighboring reconstructed Y, Cb and Cr samples in the second neighboring row and column. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block. FIG. 6 illustrates neighboring reconstructed samples used for DIMD chroma mode.
When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.

### 2.1.6 Fusion of Chroma Intra Prediction Modes

The DM mode and the four default modes can be fused with the MMLM_LT mode as follows:

$$pred = ( w 0 * p r e d 0 + w 1 * p r e d 1 + ( 1 ≪ ( shift - 1 ) ) ) ≫ shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0,w1}={2, 2}.
For the syntax design, if a non-LM mode is selected, one flag is signaled to indicate whether the fusion is applied. This method only applies to I slices.

### 2.1.7 Intra Template Matching

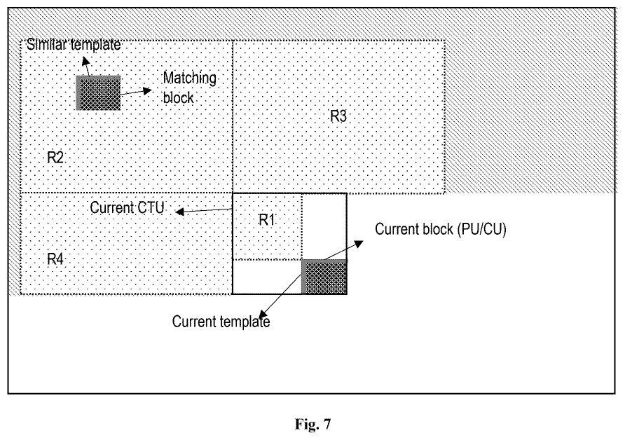

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.
The prediction signal is generated by matching the L-shaped causal neighbor of the current block with another block in a predefined search area in FIG. 7 consisting of:
R1: current CTU
R2: top-left CTU
R3: above CTU
R4: left CTU
   Sum of absolute differences (SAD) is used as a cost function.
   Within each region, the decoder searches for the template that has least SAD with respect to the current one and uses its corresponding block as a prediction block.
   The dimensions of all regions (SearchRange_w, SearchRange_h) are set proportional to the block dimension (BlkW, BlkH) to have a fixed number of SAD comparisons per pixel. That is:

$$\begin{matrix}SearchRange\_w = a * BlkW \\ SearchRange\_h = a * BlkH\end{matrix}$$

Where ‘a’ is a constant that controls the gain/complexity trade-off. In practice, ‘a’ is equal to 5.
To speed-up the template matching process, the search range of all search regions is subsampled by a factor of 2. This leads to a reduction of template matching search by 4. After finding the best match, a refinement process is performed. The refinement is done via a second template matching search around the best match with a reduced range. The reduced range is defined as min(BlkW, BlkH)/2.
The Intra template matching tool is enabled for CUs with size less than or equal to 64 in width and height. This maximum CU size for Intra template matching is configurable.
The Intra template matching prediction mode is signaled at CU level through a dedicated flag when DIMD is not used for current CU.

### 2.1.7.1 IntraTMP Derived Block Vector Candidates for IBC

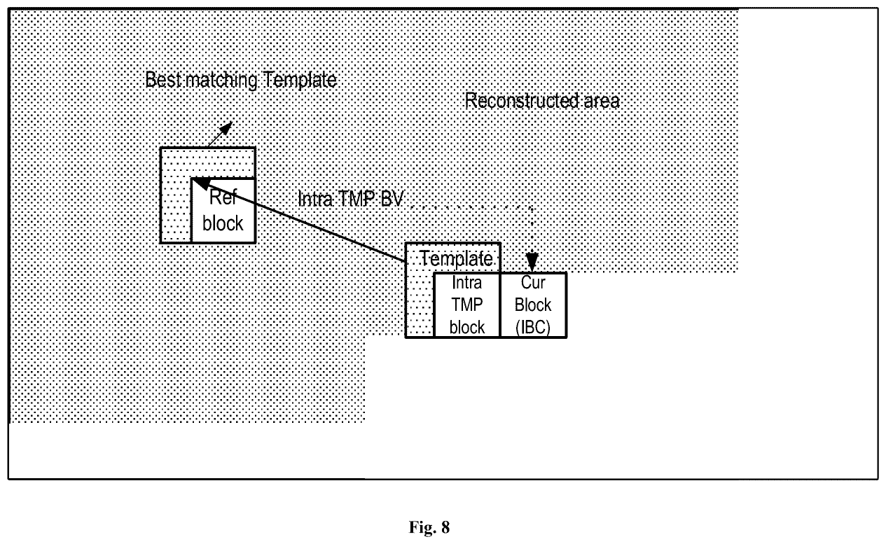

In this method block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.
IntraTMP block vector is stored in the IBC block vector buffer and, the current IBC block can use both IBC BV and IntraTMP BV of neighbouring blocks as BV candidate for IBC BV candidate list as shown in FIG. 8.
IntraTMP block vectors are added to IBC block vector candidate list as spatial candidates.

### 2.1.8 Fusion for Template-Based Intra Mode Derivation (TIMD)

For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.
The costs of the two selected modes are compared with a threshold, in the test the cost factor of 2 is applied as follows:

$$costMode 2 < 2 * costMode 1.$$

If this condition is true, the fusion is applied, otherwise the only model is used.
Weights of the modes are computed from their SATD costs as follows:

$$weight 1 = costMode 2 / ( costMode 1 + costMode 2 )$$

The division operations are conducted using the same lookup table (LUT) based integerization scheme used by the CCLM.

### 2.1.9 Intra Prediction Fusion

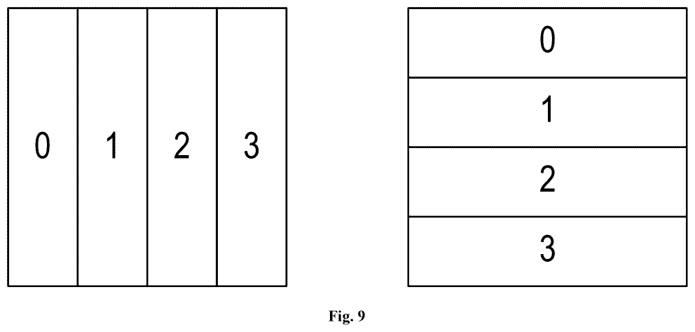

This intra prediction method derives predicted samples as a weighted combination of multiple predictors generated from different reference lines. In this process multiple intra predictors are generated and then fused by weighted averaging. The process of deriving the predictors to be used in the fusion process is described as follows:
For angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and pₗᵢₙₑ₊₁ is the prediction from the line above the default reference line. The weights are set as w₀=¾ and w₁=¼.
For TIMD mode with blending, pₗᵢₙₑ is used for the first mode (w₀=1, w₁=0) and pₗᵢₙₑ₊₁ is used for the second mode (w₀=0, w₁=1).
For DIMD mode with blending, the number of predictors selected for a weighted average is increased from 3 to 6.
   Intra prediction fusion method is applied to luma blocks when angular intra mode has non-integer slope (required reference samples interpolation) and the block size is greater than 16, it is used with MRL and not applied for ISP coded blocks. In the method studied in the sub-test a, PDPC is applied for the intra prediction mode using the closest to the current block reference line.
   2.1.10 Combination of CIP with TIMD and TM Merge
   In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.
   The TIMD derivation method is used to derive the intra prediction mode in CIIP. Specifically, the intra prediction mode with the smallest SATD values in the TIMD mode list is selected and mapped to one of the 67 regular intra prediction modes.
   In addition, it is also proposed to modify the weights (wIntra, wInter) for the two tests if the derived intra prediction mode is an angular mode. For near-horizontal modes (2<=angular mode index<34), the current block is vertically divided; for near-vertical modes (34<=angular mode index<=66), the current block is horizontally divided.
   The (wIntra, wInter) for different sub-blocks are shown in FIG. 9.

TABLE 1
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### 2.1.11 Extended Multiple Reference Line (MRL) List

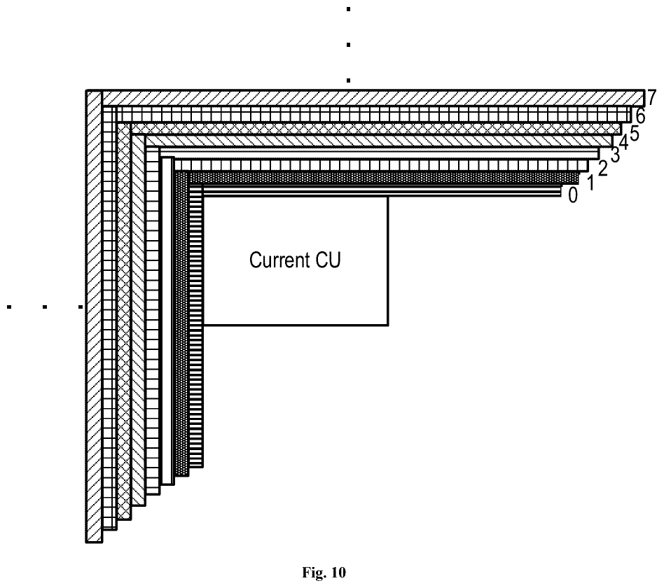

MRL list in VVC is extended to include more reference lines for intra prediction. The extended reference line list consists of line indices {1, 3, 5, 7, 12}. For template-based intra mode derivation (TIMD), instead of the full MRL candidate list, only the first two reference line candidates, i.e., {1, 3}, are used. FIG. 10 illustrates extended MRL candidate list.

### 2.1.12 Template-Based Multiple Reference Line Intra Prediction

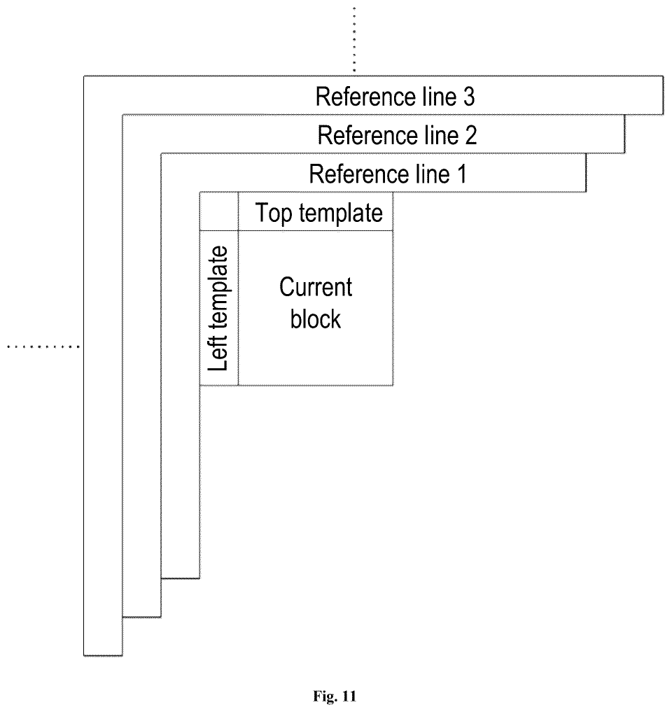

Template-based multiple reference line intra prediction (TMRL) mode combines reference line and prediction mode together and uses a template matching method to construct a list of candidate combinations. An index to the candidate combination list is coded to indicate which reference line and prediction mode is used in coding the current block. The regular multiple reference line (MRL) for the non-TIMD part is replaced by TMRL mode.
The TMRL mode extends reference line candidate list and the intra-prediction-mode candidate list. The extended reference line candidate list is {1, 3, 5, 7, 12}. The restriction on the top CTU row is unchanged. The size of the intra-prediction-mode candidate list is 10. The construction of the intra-prediction-mode candidate list is similar to MPM except the PLANAR mode is excluded from the intra-prediction-mode candidate list, DC mode is added after 5 neighboring PUs' modes and DIMD modes if its not included and the angular modes with delta angles from ±1 to ±4 (compared the existing angular modes in the intra-prediction-mode candidate list) are added.
The TMRL candidate is constructed as follows. There are 5×10=50 combinations of the extended reference line and the allowed intra-prediction modes for a block. Since the extended reference line starts from reference line 1, the area covered by reference line 0 is used for template matching. The SAD costs over the template area (see FIG. 11) are calculated between the predictions (generated by 50 combinations) and the reconstructions. The 20 combinations with the least SAD cost are selected in an ascending order to form the TMRL candidate list. FIG. 11 illustrates the template area.
   For TMR signalling instead of coding the reference line and the intra mode directly, an index to the TMRL candidate list is coded to indicate which combination of reference line and prediction mode is used for coding the current block.

### 2.1.13 Convolutional Cross-Component Intra Prediction Model

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM top, left or top and left reference samples are used as templates for model derivation.
Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.1.13.1 Convolutional Filter

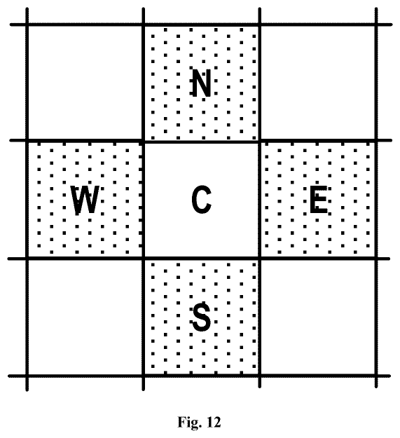

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/east (E) neighbors as illustrated in FIG. 12.
The nonlinear term P is represented as power of two of the center luma sample C and scaled to the sample value range of the content:

$$P = ( C * C + midVal ) >> bitDepth$$

That is, for 10-bit content it is calculated as:

$$P = ( C * C + 512 ) >> 10$$

The bias term B represents a scalar offset between the input and output (similarly to the offset term in CCLM) and is set to middle chroma value (512 for 10-bit content).
Output of the filter is calculated as a convolution between the filter coefficients c, and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

### 2.1.13.2 Calculation of Filter Coefficients

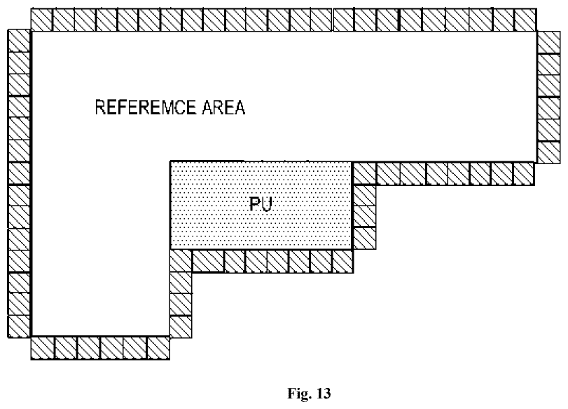

The filter coefficients cᵢ are calculated by minimising MSE between predicted and reconstructed chroma samples in the reference area. FIG. 13 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas. The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.
The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.
Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$$\begin{matrix}{C}^{′} = C - offsetLuma \\ {N}^{′} = N - offsetLuma \\ {S}^{′} = S - offsetLuma \\ {E}^{′} = E - offsetLuma \\ {W}^{′} = W - offsetLuma \\ {P}^{′} = nonLinear ( {C}^{′} ) \\ B = midValue = 1 << ( bitDepth - 1 )\end{matrix}$$

and the chroma value is predicted using the following equation, where offsetChroma is equal to offsetCr and offsetCb for Cr and Cb components, respectively:

$$predChromaVal = {c}_{0} {C}^{′} + {c}_{1} {N}^{′} + {c}_{2} {S}^{′} + {c}_{3} {E}^{′} + {c}_{4} {W}^{′} + {c}_{5} {P}^{′} + {c}_{6} B + offsetChroma$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model.
The process of CCCM model parameter calculation requires division operations. Division operations are not always considered implementation friendly. The division operation are replaced with multiplication (with a scale factor) and shift operation, where scale factor and number of shifts are calculated based on denominator similar to the method used in calculation of CCLM parameters.

### 2.1.13.3 Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.
Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

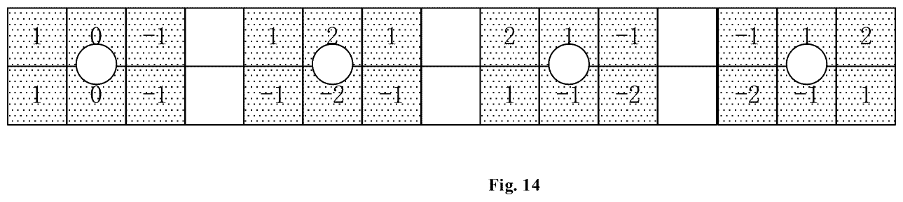

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation.
Four gradient filters are enabled for the GLM, as illustrated in FIG. 14.

### 2.1.13.4 Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA.

### 2.1.14 Spatial Geometric Partitioning Mode (SGPM)

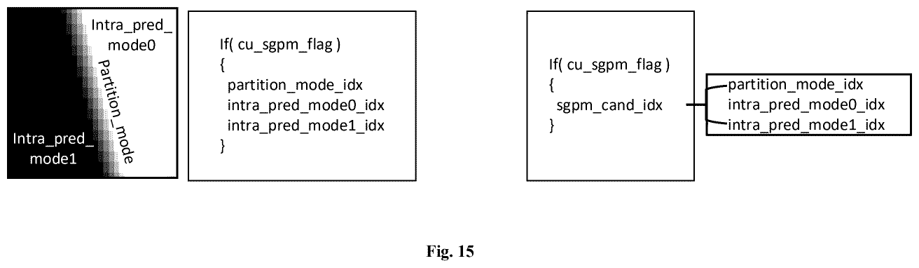

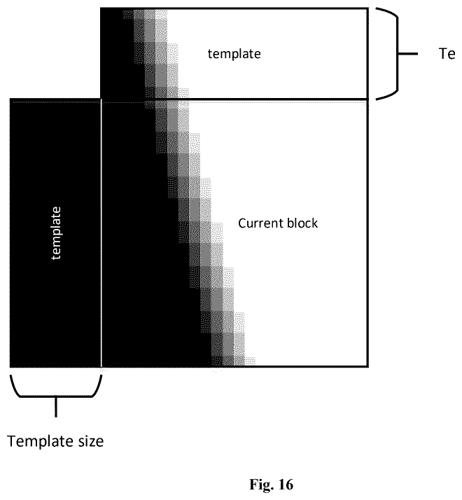

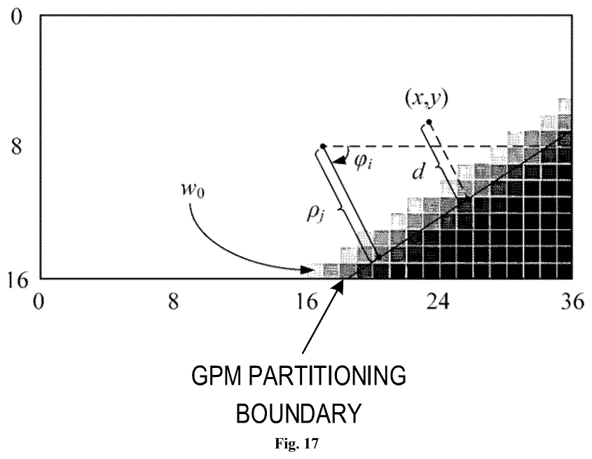

SGPM is an intra mode that resembles the inter coding tool of GPM, where the two prediction parts are generated from intra predicted process. In this mode, a candidate list is built with each entry containing one partition split and two intra prediction modes as shown in FIG. 15. 26 partition modes and 3 of intra prediction modes are used to form the combinations, the length of the candidate list is set equal to 16. The selected candidate index is signalled.
The list is reordered using template (FIG. 16) where SAD between the prediction and reconstruction of the template is used for ordering. The template size is fixed to 1.
For each partition mode, an IPM list is derived for each part using the same intra-inter GPM list derivation. The IPM list size is set to 3. In the list, TIMD derived mode is replaced by 2 derived modes with horizontal and vertical orientations.
The SGPM mode is applied with a restricted blocks size: 4<=width<=64, 4<=height<=64, width<height*8, height<width*8, width*height>=32.
Adaptive blending is also used for spatial GPM, where blending depth t shown in FIG. 17 is derived as follows:
If min(width, height)==4, ½ τ is selected.
else if min(width, height)==8, τ is selected.
else if min(width, height)==16, 2 τ is selected.
else if min(width, height)==32, 4 τ is selected.
else, 8 τ is selected.

### 2.1.15 Non-Local Cross-Component Prediction

Cross-component prediction (CCP) including CCLM, CCCM and their variants are adopted in ECM to exploit the cross-component correlation. With CCLM or CCCM, Training samples are always adjacent to the current block. However, the cross-component relationship of the current block may be more correlated to that of a non-local region.
Methods of non-local cross-component prediction are proposed to boost CCP by taking more advantage from non-local regions.

### Method #1:

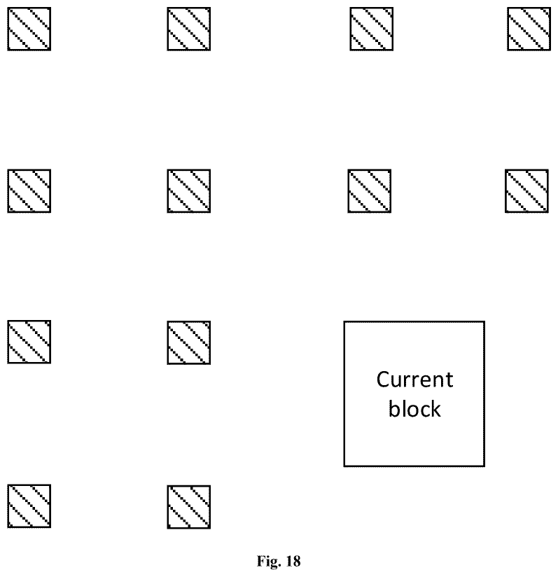

Non-adjacent cross-component prediction (NA-CCP) mode is proposed. With NA-CCP mode, Samples in regions non-adjacent to the current block can be used to derive a CCCM model for the current block. A candidate region list with 6 candidates is constructed by checking potential 8×8 regions in order. If a checked region is available, it is put into the candidate region list. The top-left positions of the potential 8×8 regions are predetermined as {(−xStep, 0), (0, −yStep), (xStep, −yStep), (−xStep, yStep), (−xStep, −yStep), (−2*xStep, 0), (0, −2*yStep), (−2*xStep, 2*yStep), (2*xStep, −2*yStep), (−2*xStep, yStep), (xStep, −2*yStep), (−2*xStep, −yStep), (−xStep, −2*yStep), (−2*xStep, −2*yStep), (−xStep/2, 0), (0, −yStep/2), (xStep/2, −yStep/2), (−xStep/2, yStep/2), (−xStep/2, −yStep/2)}, where xStep=Max(width, 16), yStep=Max(height, 16). FIG. 18 show some possible positions of candidate regions.
A flag is signaled to indicate whether NA-CCP is applied to a chroma block. If NA-CCP is applied, an index is signaled to indicate which candidate in the candidate region list is used to derive the CCCM model.

### Method #2:

History-based cross-component prediction (H-CCP) mode is proposed. With H-CCP, a H-CCLM table and a H-CCCM table are maintained similar to the HMVP table. After decoding a CCLM or CCCM coded block, the corresponding table is updated. In the implementation of H-CCP, the size of either H-CCLM table or H-CCCM table is 6. If the current block is coded with CCLM or CCCM mode, a flag is signaled to indicate whether H-CCP is applied. If H-CCP is used, an index is further signaled to indicate which candidate model in the H-CCLM table or H-CCCM table is selected.

### 2.1.16 Cross-Component Merge Mode for Chroma Intra Coding

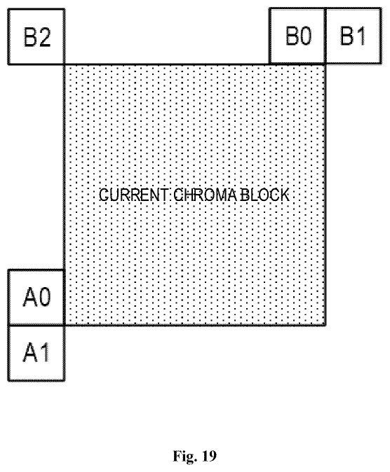

Cross-component prediction (CCP) including cross-component linear model (CCLM), convolutional cross-component model (CCCM), and gradient linear model (GLM) are adopted in ECM to exploit the cross-component correlation. A cross-component merge (CCMerge) mode is proposed as a new CCP mode. Cross component model parameters of the current chroma block coded with CCMerge can be inherited from a neighboring block coded with CCP. Through CCMerge, CCP can be more efficient with less signalling overhead. In CCMerge, final cross-component model parameters of the current chroma block can be inherited from its spatial adjacent and non-adjacent neighbors, or default models. A list is created, which includes CCP models from the spatial adjacent and non-adjacent neighbors coded in CCLM, MMLM, CCCM, GLM, chroma fusion, and CCMerge modes. After including neighboring CCP models, default models are further included to fill the remaining empty positions in the list. To avoid including redundant CCP models in the list, pruning operations are applied. More details are described as follows. FIG. 19 illustrates positions of the adjacent spatial candidates.
Spatial adjacent neighboring candidates
   Positions of the spatial adjacent candidates are shown in FIG. 19. Spatial candidates are included in the following order: B1->A1->B0->A0->B2.
Spatial non-adjacent neighboring candidates
   Spatial non-adjacent neighboring candidates are considered after all spatial adjacent neighbors are checked. In the current ECM design, in inter merge mode, two sets of spatial non-adjacent neighboring candidates are obtained. In the proposed method, positions and inclusion order of the spatial non-adjacent neighboring candidates from the first set are used.
CCLM candidates with default scaling parameters
   CCLM candidates with default scaling parameters are considered after including the spatial adjacent and non-adjacent candidates if the list is not full. The default scaling parameters are {0, ⅛, −⅛, 2/8, − 2/8, ⅜}, and the offset parameter is derived according to the selected default scaling parameter, average neighboring reconstructed luma sample value (Yavg), and average neighboring reconstructed Cb/Cr sample value (Cavg).

### 2.1.16.1 Merging Model Candidates

When merging a CCLM candidate, only the scaling parameter is inherited. The offset parameter is derived by using the inherited scaling parameter, Yavg and Cavg.
When merging a MMLM candidate, the scaling parameters and the classification threshold are inherited. The offset parameter in each class is derived according to the inherited classification threshold and the Yavg and Cavg in each class. If no neighboring reconstructed samples are available in a class, the offset parameter is directly inherited from the candidate.
When merging a CCCM candidate, all convolution parameters, offsets (i.e., offsetLuma, offsetCb, and offsetCr), and the classification threshold are inherited.
When merging a GLM candidate, if the GLM candidate is 3-parameter GLM mode, all the gradient pattern index and model parameters are inherited; otherwise, if the GLM candidate is the 2-parameter GLM mode, the offset parameter is derived by using the inherited scaling parameter, Yavg, and Cavg.
When merging a chroma fusion candidate, the derived MMLM parameters are inherited and used as merging MMLM candidate.
For a CCMerge block, if its merging candidate mode is CCLM, MMLM, CCCM, or GLM, the merging candidate mode is stored as the propagation mode of the current chroma block; otherwise, if its merging candidate mode is chroma fusion, the propagation mode is set to MMLM. When merging a CCMerge candidate, how to inherit or derive the CCP parameters depends on the propagation mode of the CCMerge candidate, as described in the above five paragraphs.

### 2.1.16.2 Signaling

An additional flag is signalled indicating whether CCMerge is used or not after cclm_mode_flag syntax element. If CCMerge is used, a candidate index is additionally signalled. The signalled candidate index is shared for Cb/Cr color components. Currently, the maximum number of allowed candidates is set to 6 as default. If maximum number of allowed candidates is modified to 1, candidate index does not need to be signalled. Each bin of candidate index is context coded with a separate context.

### 2.1.17 Directional Planar Mode

Two additional planar modes where only the horizontal interpolation or only the vertical interpolation are used to obtain the predicted samples.
For planar horizontal mode, only the horizontal linear interpolation is performed based on the left reference sample and the top-right reference sample to predict the current sample as:

$$pred ( x , y ) = ( ( W - 1 - x ) * r e c ( - 1 , y ) + ( x + 1 ) * r e c ( W , - 1 ) + ( W ≫ 1 ) ) ≫ {log}_{2} ( W )$$

For planar vertical mode, only the vertical linear interpolation is performed based on the above reference sample and the bottom-left reference sample to predict the current sample as:

$$pred ( x , y ) = ( ( H - 1 - y ) * r e c ( x , - 1 ) + ( y + 1 ) * r e c ( - 1 , H ) + ( H ≫ 1 ) ) ≫ {log}_{2} ( H )$$

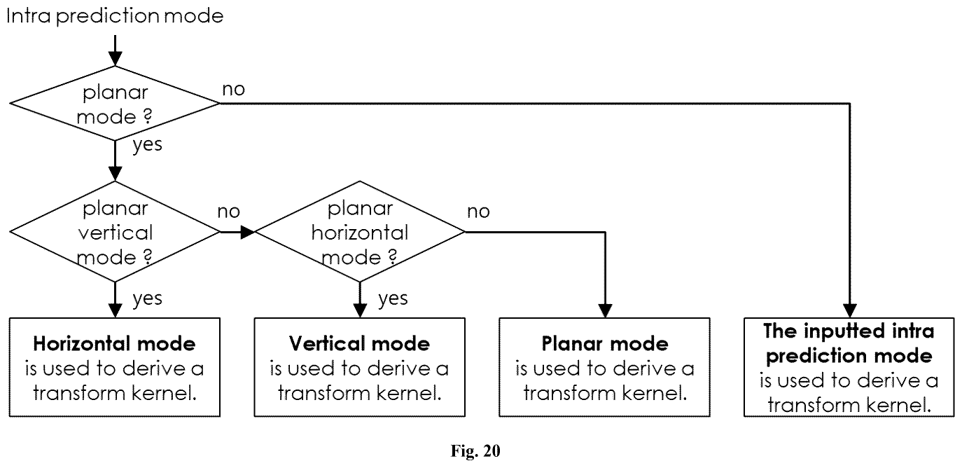

The transform kernel selection for planar horizontal and planar vertical mode is shown in FIG. 20. If an intra prediction mode of a current block is the planar vertical mode, the horizontal intra prediction mode is used to derive a transform kernel in MTS set and LFNST set. Also, if an intra prediction mode of a current block is the planar horizontal mode, the vertical intra prediction mode is used to derive a transform kernel in MTS set and LFNST set.

### 2.1.18 Direct Block Vector for Chroma Block

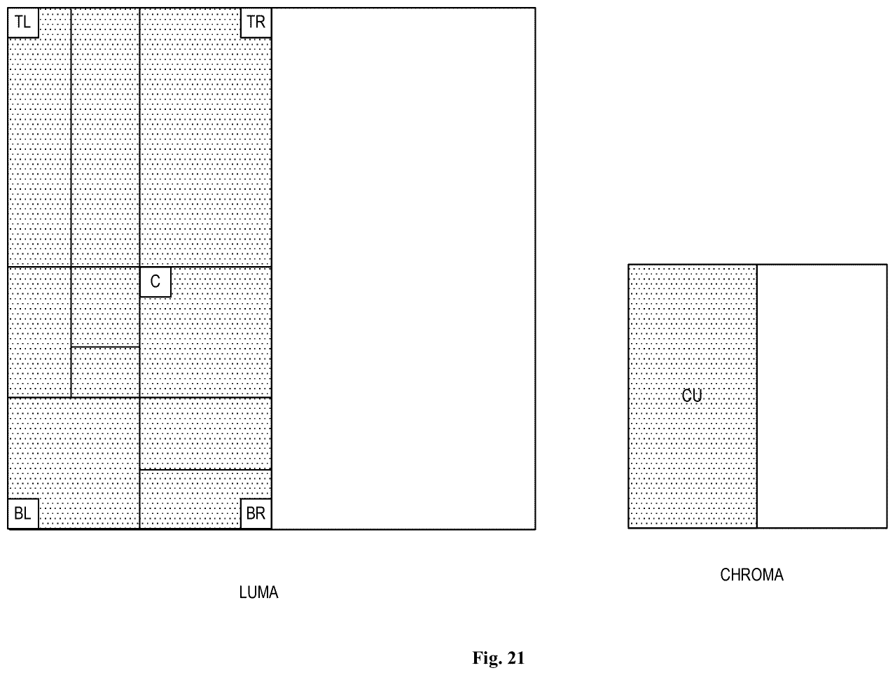

The direct block vector is used for chroma block in dual tree slices. When chroma dual tree is activated, a flag is signaled to indicate whether a chroma block is coded using IBC mode. If one of the luma blocks in five locations shown in FIG. 21 is coded with IBC or intraTMP mode, its block vector is scaled and is used as block vector for the chroma block. Template matching is used to perform block vector scaling.

### 2.2 Cross-Component Residual Model (CCRM) for Inter Prediction

### 2.2.1 Introduction

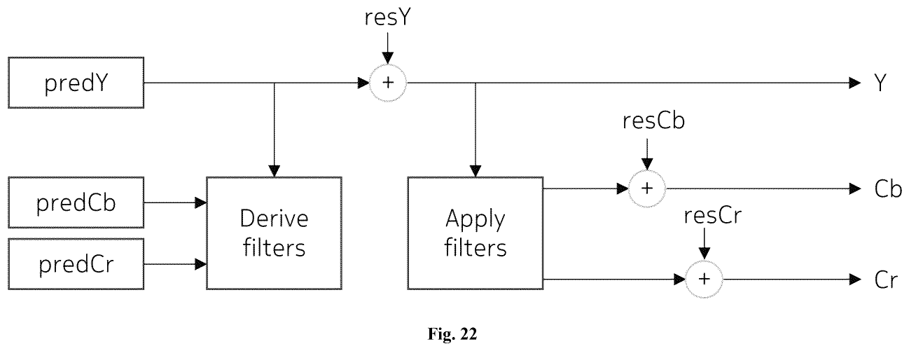

It is proposed to apply cross-component residual model (CCRM) to predict chroma samples from reconstructed luma samples when the block uses inter prediction or intra block copy (IBC). FIG. 22 illustrates the decoder side of the method. The cross-component filters are derived using the prediction signals of luma and chroma. The derived filters are applied to the reconstructed luma signal producing the final chroma predictions.

### 2.2.2 Convolutional Filter and Calculation of Filter Coefficients

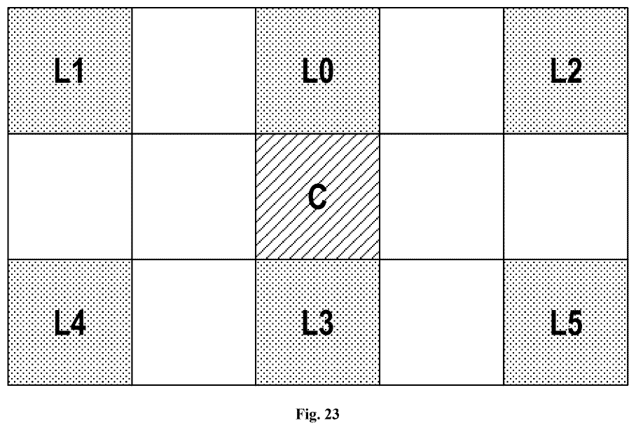

The proposed 8-tap filter consist of 6 spatial luma samples, a nonlinear term, and a bias term. The spatial luma samples (L0, . . . , L5) are obtained from the luma grid selecting the 6 luma samples closest to the chroma position C without down sampling as shown in FIG. 23. The predicted chroma value is obtained as,

$$predChromaVal = {c}_{0} L 0 + {c}_{1} L 1 + {c}_{2} L 2 + {c}_{3} L 3 + {c}_{4} L 4 + {c}_{5} L 5 + {c}_{6} nonlinear ( ( L 0 + L 3 + 1 ) ≫ 1 ) + {c}_{7} B ,$$

where nonlinear is CCCM's nonlinear operator and B is bias.
The filter coefficients are derived using ECM's division-free Gaussian elimination method and the necessary offsets are applied to samples prior to filter derivation.
Intra reference samples are used as additional input samples in filter derivation when the block has less than 64 chroma samples. CCCM's design of at most 6 rows and columns of intra reference samples is used.
Blocks having 256 chroma samples or more are divided into subblocks that have at most 256 chroma samples. Subblocks containing zero luma residual are skipped.

### 2.2.3 Bitstream Signalling

Usage of the mode is signalled with a CABAC coded TU level flag. One new CABAC context was included to support this. The CCRM flag is only signalled if the TU's luma Cbf is non-zero and the CU's predMode is either MODE_INTER or MODE_IBC.

### 3 Problems

There are several issues in the existing video coding techniques, which would be further improved for higher coding gain.
1. In ECM-8.0, CCP modes are allowed for intra chroma blocks. The CCP mode always use collocated luma samples as reference, regardless the prediction mode of the luma block. When the luma block is coded with a block vector, the CCP model made be derived differently for higher coding efficiency.
2. In ECM-8.0, DBV mode is allowed only in intra dual tree slice, which may be suboptimal.

### 4 Detailed Solutions

The detailed solutions below should be considered as examples to explain general concepts. These solutions should not be interpreted in a narrow way. Furthermore, these embodiments can be combined in any manner. The terms ‘video unit’ or ‘coding unit’ may represent a picture, a slice, a tile, a coding tree block (CTB), a coding tree unit (CTU), a coding block (CB), a CU, a PU, a TU, a PB, a TB.
The terms ‘block’ may represent a coding tree block (CTB), a coding tree unit (CTU), a coding block (CB), a CU, a PU, a TU, a PB, a TB.
The term “motion vector” or “block vector” may refer to a vector of horizontal and vertical displacements between the locations of a reference block and the current block. The reference block can be a video unit in a reference picture in the RPL list. The reference block can also be a video unit in the current picture.
The term “LM” may refer to any linear regression based method, such as CCLM, MMLM, CCCM, GL-CCCM, CCCM without downsampling, GLM, GLM with luma value, etc. It may also be referred as the term “cross-component prediction (CCP)”.
The term “CCLM” may refer to a single model LM mode, it could be single model CCLM, single model CCCM, single model GL-CCCM, single model CCCM without downsampling, single model GLM, single model GLM with luma value, multi-model CCLM, MMLM, multi-model CCCM, multi-model GL-CCCM, multi-model CCCM without downsampling, multi-model GLM, multi-model GLM with luma value, etc.
The term “MMLM” may refer to a multi-model LM mode, it could be multi-model CCLM, MMLM, multi-model CCCM, multi-model GL-CCCM, multi-model CCCM without downsampling, multi-model GLM, multi-model GLM with luma value, etc.
The term “CCCM” may refer to a regular CCCM mode, or a GL-CCCM mode, or a CCCM without downsampling, CCRM, etc.
The term “GL-CCCM” may refer to a CCCM mode which considers gradients and locations of involved samples.
The term “CCCM w/o downsampling” may refer to a CCCM mode which considers non-downsampled luma samples.
The term “CCRM” may refer to a cross-component model for residual coding.
In the document, cross-component prediction (CCP) may refer to a cross-component prediction method such as any kind of CCLM/CCCM/GLM/GL-CCCM.
It is noted that the terminologies mentioned below are not limited to the specific ones defined in existing standards. Any variance of the coding tool is also applicable.

### 4.1 About CCP Mode and Related Issues (e.g., the 1^{st} Problem), the Following Methods are Proposed:

1) How to identify/locate a set of training samples for a CCP model generation for a chroma block may be dependent on the prediction mode of at least one luma sample,
   a. For example, the luma sample may be collocated to a chroma sample of the current chroma block.
      i. For example, the chroma sample may be located at one or more positions (such as center, top-left, top-middle, top-right, bottom-left, bottom-middle, bottom-right, etc.) of the current chroma block.
   b. For example, the luma sample may be adjacent or non-adjacent to the collocated luma block of the current chroma block.
      i. For example, a first available luma block vector may be obtained according to a pre-defined checking order and position.
      ii. For example, a luma block vector may be selected from multiple available ones according to a pre-defined rule (such as template cost-based rule).
   c. For example, it may be dependent on whether the luma sample is coded with IBC mode.
   d. For example, it may be dependent on whether the luma sample is coded with intraTMP mode.
   e. For example, it may be dependent on whether the luma sample is coded with inter mode.
2) A block vector guided CCP mode may be used for a chroma block.
   a. For example, the training samples of a CCLM/MMLM/GLM/CCCM/GL-CCCM/non-downsampled-CCCM/CCRM mode may be derived based on the block vector.
   b. For example, when apply the block vector guided CCP model, collocated luma samples of the current chroma block may be used as filter input.
   c. For example, which type of block vector guided CCP mode is finally determined for the current chroma block may be explicitly signalled in the bitstream.
      i. Alternatively, it may be implicitly derived through a decoder derived method (such as template cost based method.).
3) If a block vector is available for a chroma block, such block vector guided reference block (containing both luma and chroma reference samples) may be used to derive a CCP model.
   a. For example, the coefficients of a CCP model may be derived based on the block vector identified reference block (i.e., training samples).
   b. For example, the threshold to separable samples into more than one category for a multi-model CCP mode may be derived based on the block vector identified reference block.
      i. For example, the average of luma samples values in the block vector identified reference block may be used as the threshold to separable luma and/or chroma samples in the training area (as well as the collocated luma block) into two categories.
   c. For example, in dual tree, the block vector may be derived based on a luma sample which derived based on the location of the current chroma block.
      i. For example, the luma sample may be within an area that covers the collocated luma block of the chroma block.
      ii. For example, the luma sample may be adjacent or non-adjacent to an area that covers the collocated luma block of the chroma block.
      iii. For example, the luma sample may be IBC or intraTMP coded.
   d. For example, in single tree, the block vector may be derived based on the collocated luma block of the current chroma block.
      i. For example, the luma block may be intraTMP coded.
      ii. For example, the luma block may be IBC coded.
   e. For example, the block vector may be derived based on a DBV chroma mode.
      i. For example, based on the block vector, a reference chroma block and its collocated luma block may be identified. Those samples may be used as training samples for a CCP model calculation.
   f. For example, a variant of the block vector may be used to identify a reference block for CCP model generation.
      i. For example, an offset may be added to the block vector.
      ii. For example, the block vector may be adjusted by a scaling factor.
   g. A block vector guided CCP prediction may be derived based on the reconstruction reordered IBC/intraTMP.
      i. For example, the reference region and/or the reconstruction of the block vector guided CCP chroma block may be flipped/reordered based on the flip type of the reconstruction reordered IBC/intraTMP of the luma component.
4) A restriction may be applied to the block vector for the CCP model generation.
   a. For example, the reference block pointed/identified by the block vector may not exceed the current CTU row restriction.
   b. For example, the reference block pointed/identified by the block vector may be required to not above X (e.g., X=0 or 1 or 2 or 3 or 4) CTUs way from the current CTU.
   c. For example, the reference block pointed/identified by the block vector may be required to inside the collocated CTU plus K (e.g., K=3) columns on the right.
   d. For example, if the reference block pointed/identified by the block vector breaks the pre-defined restriction, such CCP mode may not be used/allowed to the current chroma block.
      i. For example, the syntax element related to such CCP mode may not be signalled.
      ii. For example, the signalling of such CCP mode may be dependent on the condition of the restriction.
   e. For example, if the reference block pointed/identified by the block vector breaks the pre-defined restriction, the reference block may be re-positioned to a valid area.
   f. For example, if the reference block pointed/identified by the block vector breaks the pre-defined restriction, the unavailable samples of the reference block may be filled with other values.
   g. For example, if partial samples of the reference block are not valid (e.g., not decoded, or already decoded but out of the restricted area), at least one of the unavailable samples of the reference block may be padded (e.g., based on available samples).
      i. Furthermore, a threshold may be introduced to activate the padding process.
         1. For example, if less than X (such as X=¼, ½, ¾, etc.) samples of samples in the whole block are not available, padding may be used.
5) Non-downsampled luma samples may be used for block vector guided CCP mode for a chroma block.
   a. For example, the CCP model coefficients of a block vector guided CCP model may be generated by using non-downsampled luma samples of the reference area as training samples.
   b. For example, a block vector guided CCP model may be applied to a chroma block wherein the chroma samples of the current chroma block are generated based on non-downsampled luma samples of the collocated luma block.
6) Sample value and/or gradient and/or location information may be considered for the filter model design for a block vector guided CCP model.
   a. For example, at least one K-tap filter may be used for a CCP model, which consists of K1 sample term(s), K2 gradients term(s), K3 location/positional term(s), K4 non-linear term(s), K5 bias term(s), and etc.
      i. For example, K1=0 or 1 or 2 or 5 or 6.
      ii. For example, K2=0 or 1 or 2 or 4.
      iii. For example, K3=0 or 1 or 2 or 4.
      iv. For example, K4=0 or 1 or 2 or 4.
      v. For example, K5=0 or 1.
      vi. For example, K=K1+K2+K3+K4+K5.
      vii. For example, the sample term may be calculated based on luma sample values.
      viii. For example, the gradient term may be calculated based on more than one sample adjacent to a certain luma sample.
      ix. For example, the location/positional term may be calculated based on horizontal and/or vertical coordinates of a certain luma sample, wherein the coordinate may be relative to the top-left position of a certain reference area.
      x. For example, the non-linear term may be a square of a certain value (e.g., a bit-depth related mid value such as 512 or 256, or a certain luma value).
      xi. For example, the non-linear term may be a square of a gradient value based on a certain gradient term.
      xii. For example, an offset may be subtracted from a term of the K-tap filter.
         1. For example, the offset may be derived based on a pre-defined rule (such as the value of the top-left training sample in the training area, or an average/mid value of more than one sample in the training area).
      xiii. For example, the coefficients of the K-tap filter may be solved by a gaussian elimination solver.
      xiv. For example, the coefficients of the K-tap filter may be solved by an LDL decomposition method.
      xv. For example, the coefficients of the K-tap filter may be solved by linear regression.
      xvi. For example, the coefficients of the K-tap filter may be solved by linear equation.
   b. For example, more than one filter may be used, and the final prediction may be derived based on fuse multiple filtered values together.
      i. For example, the weights to fuse multiple filtered values may be solved by a gaussian elimination solver.
      ii. For example, the weights to fuse multiple filtered values may be solved by an LDL decomposition method.
7) The filter output may be clipped to a value.
   a. For example, it may be clipped based on the reconstruction values in the training area.
      i. For example, the training area may be derived based on a block vector.
      ii. For example, the training area may be adjacent to the current block.
      iii. For example, the training area may be a reference region of the current block.
      iv. For example, it may be clipped within the min and max of the reconstructed (or predicted) luma samples values in a training area.
   b. For example, it may be clipped based on the reconstruction values (or predicted values) in the collocated luma block of current chroma block.
      i. For example, it may be clipped within the min and max of the current block luma reconstructed values (or predicted values).
   c. For example, it may be ignored/discarded/not used if the value is outside of a valid range.
8) Whether to use block vector guided or non-block-vector guided reference samples for a CCP model generation for a chroma block, may be determined based on template cost.
   a. For example, the determination may be made at both decoder side and encoder side (e.g., without signalling).
   b. For example, there may be no need to signal a syntax element to indicate whether to use block vector guided or non-block-vector guided reference samples for a CCP model generation.
   c. For example, firstly, a first CCP model may be generated by using non-block-vector guided reference samples as training samples, and such CCP model is applied to template samples, a first template cost is then calculated by comparing the difference between model-estimated prediction values of template samples and true reconstruction values of template samples; secondly, a second CCP model may be generated by using block-vector guided reference samples as training samples, and such CCP model is applied to template samples, a second template cost is then calculated by comparing the difference between model-estimated prediction values of template samples and true reconstruction values of template samples; thirdly, a final set of training samples with less template cost (by comparing the first template cost and the second template cost) may be determined as the final training samples and its corresponding CCP model is used as the final CCP model for the current chroma block coding.
   d. For example, the non-block-vector guided reference samples may refer to M rows and N columns of neighboring chroma samples adjacent to the current chroma block (e.g., M=2 or 4 or 6, N=2 or 4 or 6).
      i. For example, the non-block-vector guided reference samples may refer to s*M rows and s*N columns of neighboring luma samples adjacent to the collocated luma block, wherein s indicates a scaling factor dependent on chroma format (e.g., s=2 for 4:2:0 chroma format).
         1. For example, neighboring luma samples are non-downsampled.
      ii. For example, the non-block-vector guided reference samples may refer to M rows and N columns of neighboring luma samples adjacent to the collocated luma block.
         1. For example, neighboring luma samples are downsampled based on the chroma format.
   e. For example, the block-vector guided reference samples may refer to luma and chroma samples inside the reference block which is identified by the block vector.
9) The usage of a block-vector guided CCP mode may be singled in the bitstream.
   a. For example, it may be signalled based on an availability of an IBC coded luma block.
   b. For example, it may be signalled based on an availability of an intraTMP coded luma block.
   c. For example, it may be signalled based on an availability of an inter coded luma block.
   d. For example, whether a block-vector guided CCP mode is used for a chroma block may be signalled in the intra chroma mode syntax structure.
      i. Alternatively, it may be signalled in the IBC mode syntax structure.
      ii. Alternatively, it may be signalled in the inter mode syntax structure.
   e. For example, whether a block-vector guided CCP mode is used for a chroma block may be signalled conditioned on the usage of a certain CCCM mode (e.g., CCCM/GL-CCCM/non-downsample-CCCM flag).
   f. For example, whether a block-vector guided CCP mode is used for a chroma block may be signalled conditioned on the usage of a certain GLM mode (e.g., GLM flag/index, etc.).
   g. For example, whether a block-vector guided CCP mode is used for a chroma block may be signalled conditioned on a certain LM mode (e.g., single model or multiple model, TL mode or T only mode or L only mode).
10) CCP model parameters of a block-vector guided CCP coded block may be stored in a buffer and used for a future block's coding.
   a. For example, the CCP model parameters for a video unit (e.g., CU, PU, color component, Cb, Cr, etc.) may include CCP mode type, model coefficients, whether it is single model or multiple models, threshold to separate samples into multiple models, and etc.
   b. For example, it may be stored in a local buffer for the coding of a future block in the current picture.
   c. For example, it may be stored in a temporal or picture buffer for the coding of a future block in a future decoded picture.
      i. For example, it may be stored associated with the motion and mode information of a video unit.
   d. For example, a future block may inherit the CCP model parameters from a block-vector guided CCP coded neighbor block.
      i. For example, the future block may be coded by a non-local CCP mode.
      ii. For example, the future block may be coded by a CCP merge (e.g., CCmerge) mode.
11) The final prediction of a block-vector guided CCP coded block may be generated based on multiple prediction candidates from different block-vector guided CCP models.
   a. For example, more than one block-vector guided CCP model prediction may be fused together.
   b. For example, the weights/coefficients of different fusion terms may be solved based on a Gaussian elimination method.
   c. For example, the weights/coefficients of different fusion terms may be solved based on an LDL decomposition method.
   d. For example, a bias term may be involved for the fusion.
   e. For example, a non-linear term may be involved for the fusion.
12) The disclosed CCP mode may be one of the following modes:
   a. CCLM and/or its variant.
   b. MMLM and/or its variant.
   c. CCCM and/or its variant (e.g., GL-CCCM, non-downsampled-CCCM, BVG-CCCM, CCRM, etc.).
   d. GLM and/or its variant.
   e. CCRM and/or its variant.
   f. Any cross-component prediction that uses information in one channel/component to predict information in another channel/component.
   g. Any filter-based prediction wherein the filter coefficients are solved based on correlation between prediction and/or reconstruction information.
13) Block restrictions may be applied to limit the application of a certain type of CCP mode.
   a. For example, a CCP mode may only be allowed to be used for block sizes satisfies a pre-defined rule.
   b. For example, syntax elements may be signalled only when the CCP mode is applicable.
   c. For example, if the CCP mode is not allowed to be used, syntax elements may be inferred to a certain value indicating no such CCP mode is used for such block.
   d. For example, at least one of the following block restrictions may be applied to the CCP mode (suppose W denotes the block width, and H denotes the block height):
      i. W<T1, or, W<=T1
      ii. H<T2, or, H<=T2
      iii. Min (W,H)>T3, or, Min (W,H)>=T3
      iv. Max (W,H)<T4, or, Max (W,H)<=T4
      v. W<T5*H, or, W<=T5*H
      vi. W>T6*H, or, W>=T6*H
      vii. H<T7*W, or, H<=T7*W
      viii. H>T8*W, or, H>=T8*W
      ix. W*H<T9, or W*H<=T9
      x. For example, T1, T2, . . . T9 may be pre-defined integer constants.
   e. For example, a certain type of CCP mode may be allowed for small blocks only.
      i. For example, it may be allowed for blocks smaller than 4×4, or 8×8, or 16×16, or 32×32.
      ii. For example, it may be allowed for blocks with number of samples less than 32, or, 64, or 128.
      iii. For example, it may be allowed for blocks with number of samples less than 32, or, 64, or 128.
      iv. For example, it may not be allowed for 2×N blocks, wherein N may be greater than 4 or 8 or 16.
      v. For example, it may not be allowed for N×2 blocks, wherein N may be greater than 4 or 8 or 16.
14) The disclosed method may be used in single tree.
   a. For example, if the collocated luma block is coded with intraTMP mode, the chroma block may be coded with a CCP mode and the CCP model is generated based on the block vector of the intraTMP coded luma block.
15) The disclosed method may be used in dual tree.
   a. For example, if the collocated luma block is coded with IBC or intraTMP mode, the chroma block may be coded with a CCP mode and the CCP model is generated based on the block vector of the IBC or intraTMP coded luma block.
16) The disclosed method may be used in a inter (such as B or P) slice.
17) The disclosed method may be used in an intra (such as I) slice.
18) The “block vector” in the disclosed method may be a “motion vector”.
19) The training/reference sample in the disclosed method may refer to prediction sample and/or reconstruction sample in the training/reference area.

### 4.2 About DBV Mode and Related Issues (e.g., the 2^{nd} Problem), the Following Methods are Proposed:

1) DBV mode may be used/allowed in inter slices.
   a. For example, DBV may be used for a block in a inter B or P slice.
   b. For example, in an inter slice, when a luma block is intraTMP coded, its chroma block may be coded with DBV mode.
   c. For example, in an inter slice, a syntax element may be signalled to indicate a DBV coded chroma block.
2) DBV may be used/allowed in single tree.
   a. For example, DBV may be used for a block in a single tree intra slice.
   b. For example, in single tree, when a luma block is intraTMP coded, its chroma block may be coded with DBV mode.
   c. For example, in single tree, a syntax element may be signalled to indicate a DBV coded chroma block.
3) DBV may be used/allowed for camera captured video content.
4) The block vector of a DBV coded chroma block may be in fractional precision.
   a. Alternatively, it may be in integer precision.
5) In single tree and/or inter slices, the block vector of a DBV coded chroma block may be derived from a luma block vector.
   a. For example, the luma block vector may be derived from a collocated to the chroma block.
   b. For example, the luma block vector may be derived from a luma block adjacent or non-adjacent to the collocated luma block.
      i. For example, a first available luma block vector may be obtained according to a pre-defined checking order and position.
      ii. For example, a luma block vector may be selected from multiple available ones according to a pre-defined rule (such as template cost-based rule).
   c. For example, to calculate the chroma block block, an offset may be used to adjust a luma block vector (e.g., assume downsampleRatio_width and downsampleRatio_height are downsampling factors dependent on color format).
      i. chromaBV_hor=lumaBV_hor*downsampleRatio_width+offsetX
      ii. chromaBV_ver=lumaBV_ver*downsampleRatio_height+offsetY
      iii. For example, offsetX and offsetY may be negative or positive values. For example, offsetX and offsetY may be dependent on the reconstruction reorder type (e.g., flip type, RRIBC type, RRTMP type) of the luma block.
         4.3 Whether to and/or how to apply the disclosed methods above may be signalled at sequence level/group of pictures level/picture level/slice level/tile group level, such as in sequence header/picture header/SPSNPS/DPS/DCI/PPS/APS/slice header/tile group header.
         4.4 Whether to and/or how to apply the disclosed methods above may be signalled at PB/TB/CB/PU/TU/CU/VPDU/CTU/CTU row/slice/tile/sub-picture/other kinds of region contain more than one sample or pixel.
         4.5 Whether to and/or how to apply the disclosed methods above may be dependent on coded information, such as block size, colour format, single/dual tree partitioning, colour component, slice/picture type.

The term “block vector guided CCP mode” used herein may refer to a certain CCP mode derived based on a block vector. For example, the block vector guided CCP mode may include BVG-CCCM mode. The term “motion vector guided CCP mode” used herein may refer to a certain CCP mode derived based on a motion vector. The terms “CCP model” and “CCP filter” may be used interchangeably. The term “model coefficient” used herein may also refer to “filter coefficient” or “filter parameter.” The LDL decomposition may be represented as A=LDL*, where L is a lower unit triangular (unitriangular) matrix, and D is a diagonal matrix.

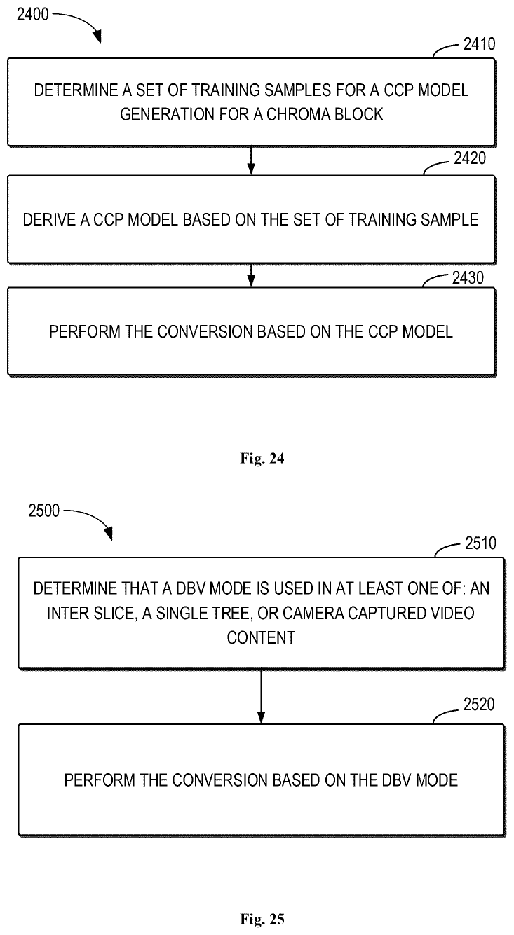

FIG. 24 illustrates a flowchart of a method 2400 for video processing in accordance with embodiments of the present disclosure. The method 2400 is implemented during a conversion between a video unit of a video and a bitstream of the video.

At block 2410, for a conversion between a video unit of a video and a bitstream of the video, a set of training samples for a cross-component prediction (CCP) model generation for a chroma block is determined based on at least one of: a prediction mode of at least one luma sample, a block vector, a motion vector, a reference block identified by the block vector, or a reference block identified by the motion vector.

At block 2420, a CCP model is derived based on the set of training sample.

At block 2430, the conversion is performed based on the CCP model. In some embodiments, the conversion includes encoding the video unit into the bitstream. Alternatively, the conversion includes decoding the video unit from the bitstream.

The method 2400 enables a CCP model to be derived differently. Compared with the conventional solution, embodiments of the present disclosure can achieve higher coding efficiency advantageously.

In some embodiments, the at least one luma sample may be collocated to a chroma sample of a current chroma block. In some embodiments, the chroma sample may be located at one or more positions of the current chroma block. In some embodiments, the one or more positions of the current chroma block may comprise at least one of: center of the current chroma block, top-left of the current chroma block, top-middle of the current chroma block, top-right of the current chroma block, bottom-left of the current chroma block, bottom-middle of the current chroma block, or bottom-right of the current chroma block.

In some embodiments, the at least one luma sample may be adjacent to a collocated luma block of a current chroma block. In some other embodiments, the at least one luma sample may be non-adjacent to a collocated luma block of a current chroma block.

In some embodiments, a first available luma block vector or motion vector may be obtained according to a pre-defined checking order and position. In some embodiments, a luma block vector or motion vector may be selected from a plurality of available luma block vectors or motion vectors according to a pre-defined rule. In some embodiments, the pre-defined rule may be a template cost-based rule.

In some embodiments, the determination of the set of training samples may be dependent on whether the at least one luma sample is coded with intra block copy (IBC) mode. In some other embodiments, the determination of the set of training samples may be dependent on whether the at least one luma sample is coded with intra template matching prediction (intraTMP) mode. Alternatively, the determination of the set of training samples may be dependent on whether the at least one luma sample is coded with inter mode.

In some embodiments, a block vector or motion vector guided CCP mode may be used for a chroma block. In some embodiments, at least one of the followings may be derived based on the block vector or the motion vector: one or more training samples of a cross-component linear model (CCLM), one or more training samples of a multi-model linear model (MMLM), one or more training samples of a gradient linear model (GLM), one or more training samples of convolutional cross-component model (CCCM), one or more training samples of a gradient linear-convolutional cross-component model (GL-CCCM), one or more training samples of non-downsampled-CCCM, or one or more training samples of cross-component residual model (CCRM) mode.

In some embodiments, if the block vector or motion vector guided CCP model is applied, collocated luma samples of the current chroma block may be used as filter input. In some embodiments, which type of the block vector or motion vector guided CCP mode is finally determined for the current chroma block may be signalled in the bitstream.

In some embodiments, which type of the block vector or motion vector guided CCP mode is finally determined for the current chroma block may be derived through a decoder derived approach. In some embodiments, the decoder derived approach may be a template cost based approach. In some embodiments, if the block vector or the motion vector is available for the chroma block, the reference block identified by the block vector or the motion vector may be used to derive the CCP model, where the block vector or the motion vector guided reference block comprises both luma and chroma reference samples.

In some embodiments, coefficients of the CCP model may be derived based on the block vector or motion vector identified reference block. For example, a threshold to separate samples into more than one category for a multi-model CCP mode is derived based on the block vector or motion vector identified reference block. In some embodiments, an average of luma samples values in the block vector or motion vector identified reference block may be used as the threshold to separable luma and/or chroma samples in a training area into two categories. Alternatively, an average of luma samples values in the block vector or motion vector identified reference block may be used as the threshold to separable luma and/or chroma samples in a collocated luma block into two categories.

In some embodiments, in dual tree, the block vector or the motion vector may be derived based on a luma sample which derived based on location of the current chroma block. In some embodiments, the luma sample may be within an area that covers a collocated luma block of the current chroma block. In some embodiments, the luma sample may be adjacent or non-adjacent to an area that covers a collocated luma block of the current chroma block. In some other embodiments, the luma sample may be IBC or intraTMP coded.

In some embodiments, in single tree, the block vector or the motion vector may be derived based on a collocated luma block of the current chroma block. In some embodiments, the collocated luma block may be intraTMP coded. Alternatively, the collocated luma block may be IBC coded.

In some embodiments, the block vector or the motion vector may be derived based on a direct block vector (DBV) chroma mode. In some embodiments, based on the block vector or the motion vector, a reference chroma block and collocated luma block of the reference chroma block may be identified. In some embodiments, a sample of at least one of: the reference chroma block or the collocated luma block of the reference chroma block may be used as a training sample for a CCP model calculation.

In some embodiments, a variant of the block vector or the motion vector may be used to identify a reference block for the CCP model generation. In some embodiments, an offset may be added to the block vector or the motion vector. In some other embodiments, the block vector or the motion vector may be adjusted by a scaling factor.

In some embodiments, the block vector or motion vector guided CCP prediction may be derived based on a reconstruction reordered IBC or intraTMP. In some embodiments, at least one of: a reference region or a reconstruction of the block vector or motion vector guided CCP chroma block may be flipped based on a flip type of a reconstruction reordered IBC or intraTMP of the luma component. In some other embodiments, at least one of: a reference region or a reconstruction of the block vector or motion vector guided CCP chroma block may be reordered based on a flip type of a reconstruction reordered IBC or intraTMP of the luma component.

In some embodiments, a restriction may be applied to a block vector or motion vector for the CCP model generation. In some embodiments, a reference block pointed by the block vector or motion vector may not exceed a current coding tree unit (CTU) row restriction. Alternatively, a reference block identified by the block vector or motion vector may not exceed a current coding tree unit (CTU) row restriction.

In some embodiments, a reference block pointed by the block vector or motion vector may be required to not above a predetermined number of CTUs away from the current CTU. Alternatively, a reference block identified by the block vector or motion vector may be required to not above a predetermined number of CTUs away from the current CTU. In some embodiments, the predetermined number may equal to one of: 0, 1, 2, 3, or 4.

In some embodiments, a reference block pointed by the block vector or motion vector may be required to inside a collocated CTU plus a predetermined number of columns on the right. In some other embodiments, a reference block identified by the block vector or motion vector may be required to inside a collocated CTU plus a predetermined number of columns on the right. In some embodiments, the predetermined number may equal to 3.

In some embodiments, if a reference block pointed or identified by the block vector or motion vector breaks the pre-defined restriction, a CCP mode may be not used or allowed to a current chroma block. In some embodiments, a syntax element related to the CCP mode may be not signalled. In some other embodiments, a signalling of the CCP mode may be dependent on a condition of a restriction.

In some embodiments, if a reference block pointed or identified by the block vector or motion vector breaks the pre-defined restriction, the reference block may be re-positioned to a valid area. In some other embodiments, if a reference block pointed or identified by the block vector or motion vector breaks the pre-defined restriction, an unavailable sample of the reference block may be filled with other values.

In some embodiments, if partial samples of a reference block are not valid, the unavailable sample of the reference block may be padded. In some embodiments, partial samples of a reference block are not valid may comprise at least one of: partial samples of a reference block are not decoded; or partial samples of a reference block are already decoded but out of a restricted area. In some embodiments, the unavailable sample of the reference block may be padded based on available samples.

In some embodiments, a threshold may be used to activate the padding process. For example, if less than a proportion of samples of samples in a whole block are not available, the padding process may be used. In some embodiments, the proportion may equal to ¼, ½, or ¾.

In some embodiments, a non-downsampled luma sample may be used for a block vector or motion vector guided CCP mode for the chroma block. In some embodiments, coefficients of the CCP model of a block vector or motion vector guided CCP model may be generated by using non-downsampled luma samples of the reference area as training samples. In some embodiments, a block vector or motion vector guided CCP model may be applied to a chroma block, where a chroma sample of the current chroma block is generated based on the non-downsampled luma sample of a collocated luma block.

In some embodiments, at least one of: sample value, gradient, or location information may be used for determining a filter model for a block vector or motion vector guided CCP model. In some embodiments, at least one of a first number-tap filter may be used for a CCP model, which comprises a second number of sample terms, a third number of gradients terms, a fourth number of location or positional terms, a fifth number of non-linear terms, a sixth number of bias terms. In some embodiments, the second number may equal to one of: 0, 1, 2, 5, or 6. In some embodiments, the third number may equal to one of: 0, 1, 2, or 4. In some embodiments, the fourth number may equal to one of: 0, 1, 2, or 4. In some embodiments, the fifth number may equal to one of: 0, 1, 2, or 4. In some embodiments, the sixth number may equal to one of: 0 or 1. In some embodiments, the first number may equal to a sum of the second number, the third number, the fourth number, the fifth number and the sixth number.

In some embodiments, the sample term may be calculated based on luma sample values. In some embodiments, the gradient term may be calculated based on a plurality of sample adjacent to a luma sample. In some other embodiments, the location or positional term may be calculated based on horizontal and/or vertical coordinates of a luma sample. In this case, the coordinate may be relative to top-left position of a reference area.

In some embodiments, the non-linear term may be a square of a value. In some embodiments, the square of a value may be a bit-depth related mid value or a luma value. In some other embodiments, the bit-depth related mid value may be 512 or 256. Alternatively, the non-linear term may be a square of a gradient value based on a gradient term.

In some embodiments, an offset may be subtracted from a term of the first number-tap filter. Alternatively, the offset may be derived based on a pre-defined rule. For example, the pre-defined rule may be a value of a top-left training sample in a training area, or an average or mid value of a plurality of samples in the training area.

In some embodiments, a coefficient of the first number-tap filter may be determined by a gaussian elimination solver. In some embodiments, a coefficient of the first number-tap filter may be determined by an LDL decomposition approach. In some embodiments, a coefficient of the first number-tap filter may be determined by linear regression. In some other embodiments, a coefficient of the first number-tap filter may be determined by linear equation.

In some embodiments, a plurality of filters may be used, and a final prediction may be derived based on fusing a plurality of filtered values together. In some embodiments, weights to fuse the plurality of filtered values may be determined by a gaussian elimination solver. Alternatively, weights to fuse the plurality of filtered values may be determined by an LDL decomposition approach.

In some embodiments, a filter output may be clipped to a value. In some embodiments, the filter output may be clipped based on reconstruction values in a training area.

In some embodiments, the training area may be derived based on the block vector or the motion vector. In some embodiments, the training area may be adjacent to a current block. In some other embodiments, the training area may be a reference region of a current block.

In some embodiments, the filter output may be clipped within minimum and maximum of reconstructed luma samples values in a training area. In some other embodiments, the filter output may be clipped within minimum and maximum of predicted luma samples values in a training area.

In some embodiments, the filter output may be clipped based on reconstruction values in the collocated luma block of a current chroma block. In some other embodiments, the filter output may be clipped based on predicted values in the collocated luma block of a current chroma block.

In some embodiments, the filter output may be clipped within minimum and maximum of the current block luma reconstructed values. In some other embodiments, the filter output may be clipped within minimum and maximum of the current block luma predicted values. In some embodiments, the filter output may be ignored, discarded, or not used if the value is outside of a valid range.

In some embodiments, whether to use block vector guided, motion vector guided, non-motion-vector guided, or non-block-vector guided reference samples for a CCP model generation for a chroma block, may be determined based on template cost. In some embodiments, the determination of whether to use block vector guided, motion vector guided, non-motion-vector guided, or non-block-vector guided reference samples may be made at both decoder side and encoder side. In some embodiments, the determination may be made at both decoder side and encoder side without signalling. In some embodiments, there may be no need to signal a syntax element to indicate whether to use block vector guided, motion vector guided, non-motion-vector guided, or non-block-vector guided reference samples for a CCP model generation.

In some embodiments, a first CCP model may be generated by using the non-block-vector guided reference samples as training samples, and the first CCP model is applied to template samples, a first template cost is then calculated by comparing difference between model-estimated prediction values of template samples and true reconstruction values of template samples; a second CCP model may be generated by using the block-vector guided reference samples as training samples, and the second CCP model is applied to template samples, a second template cost is then calculated by comparing difference between model-estimated prediction values of template samples and true reconstruction values of template samples; and by comparing the first template cost and the second template cost, a final set of training samples with less template cost may be determined as the final training samples and corresponding CCP model of the final training samples is used as the final CCP model for the current chroma block coding.

In some embodiments, the non-block-vector guided reference samples may be a first number of rows and a second number of columns of neighboring chroma samples adjacent to the current chroma block. In some embodiments, the first number may equal to 2, 4, or 6; and the second number may equal to 2, 4, or 6.

In some embodiments, the non-block-vector guided reference samples may be a third number multiplying the first number of rows and the third number multiplying the second number of columns of neighboring luma samples adjacent to a collocated luma block, where the third number indicates a scaling factor dependent on chroma format. In some embodiments, the third number may equal to 2 for 4:2:0 chroma format. In some embodiments, the neighboring luma sample may be non-downsampled.

In some embodiments, the non-block-vector guided reference samples may be the first number of rows and the second number of columns of neighboring luma samples adjacent to a collocated luma block. In some embodiments, the neighboring luma sample may be downsampled based on a chroma format. In some embodiments, the block-vector guided reference samples may be luma and chroma samples inside a reference block which is identified by the block vector or the motion vector.

In some embodiments, usage of a block-vector guided CCP mode may be singled in bitstream. In some embodiments, the usage of a block-vector guided CCP mode may be signalled based on an availability of an IBC coded luma block. In some embodiments, the usage of a block-vector guided CCP mode may be signalled based on an availability of an intraTMP coded luma block. In some other embodiments, the usage of a block-vector guided CCP mode may be signalled based on an availability of an inter coded luma block.

In some embodiments, whether the block-vector guided CCP mode is used for a chroma block may be signalled in an intra chroma mode syntax structure. In some embodiments, whether the block-vector guided CCP mode is used for a chroma block may be signalled in an IBC mode syntax structure. In some embodiments, whether the block-vector guided CCP mode may be used for a chroma block may be signalled in an inter mode syntax structure. In some other embodiments, whether the block-vector guided CCP mode may be used for a chroma block may be signalled conditioned on usage of a CCCM mode. In some embodiments, the CCCM mode may comprise at least one of: CCCM, GL-CCCM, or non-downsample-CCCM flag.

In some embodiments, whether the block-vector guided CCP mode may be used for a chroma block is signalled conditioned on usage of a GLM mode. In some embodiments, the GLM mode may comprise at least one of: GLM flag or index.

In some embodiments, whether the block-vector guided CCP mode may be used for a chroma block is signalled conditioned on a LM mode. In some embodiments, the LM mode may comprise at least one of: single model, multiple model, top-left mode, top only mode, or left only mode.

In some embodiments, parameters of the CCP model of the video unit which is block-vector guided CCP coded may be stored in a buffer and used for coding of a future block. For example, the parameters of the CCP model of the video unit may comprise at least one of: CCP mode type, model coefficients, whether the CCP model is single model or multiple models, or threshold to separate samples into multiple models. In some other embodiments, the parameters of the CCP model of the video unit may comprise at least one of: coding unit (CU), prediction unit (PU), color component, Cb, or Cr.

In some embodiments, the parameters of the CCP model of a block-vector guided CCP coded block may be stored in a local buffer for the coding of a future block in a current picture. In some other embodiments, the parameters of the CCP model of a block-vector guided CCP coded block may be stored in a temporal or picture buffer for the coding of a future block in a future decoded picture. Alternatively, the parameters of the CCP model of a block-vector guided CCP coded block may be stored associated with motion and mode information of a video unit.

In some embodiments, a future block may inherit the CCP model parameters from a block-vector guided CCP coded neighbor block. In some embodiments, the future block may be coded by a non-local CCP mode. In some other embodiments, the future block may be coded by a CCP merge mode. In some embodiments, the CCP merge may be cross-component merge (CCmerge).

In some embodiments, a final prediction of a block-vector guided CCP coded block may be generated based on a plurality of prediction candidates from different block-vector guided CCP models. In some embodiments, a plurality of block-vector guided CCP model predictions may be fused together.

In some embodiments, weights or coefficients of different fused CCP models may be determined based on a Gaussian elimination approach. In some other embodiments, weights or coefficients of different fused CCP models may be determined based on an LDL decomposition approach.

In some embodiments, a bias CCP model may be involved for a fusion. Alternatively, a non-linear CCP model may be involved for a fusion.

In some embodiments, the CCP mode may be one of: CCLM, a variant of CCLM, MMLM, a variant of MMLM, CCCM, a variant of CCCM, GLM, a variant of GLM, CCRM, a variant of CCRM, a cross-component prediction that uses information in one channel or one component to predict information in another channel or another component, and/or a filter-based prediction. For example, the filter coefficients are determined based on correlation between prediction and/or reconstruction information.

In some embodiments, a block restriction may be applied to limit an application of a type of a CCP mode. In some other embodiments, a CCP mode may be only allowed to be used for a block size satisfying a pre-defined rule.

In some embodiments, a syntax element may be signalled if the CCP mode is applicable. In some other embodiments, if the CCP mode is not allowed to be used, a syntax element may be inferred to a value indicating the CCP mode is not used for the block.

In some embodiments, at least one of the following block restrictions may be applied to the CCP mode: block width is smaller than a first number, or block width is smaller than or equals to the first number; block height is smaller than a second number, or block height is smaller than or equals to the second number; minimum of block width and block height is bigger than a third number, or the minimum one of block width and block height is bigger than or equals to the third number; maximum of block width and block height is smaller than a fourth number, or the maximum of block width and block height is smaller than or equals to the fourth number; block width is smaller than a fifth number multiplying block height, or block width is smaller than or equals to the fifth number multiplying block height; block width is bigger than a sixth number multiplying block height, or block width is bigger than or equals to the sixth number multiplying block height; block height is smaller than a seventh number multiplying block width, or block height is smaller than or equals to a seventh number multiplying block width; block height is bigger than an eighth number multiplying block width, or block height is bigger than or equals to the eighth number multiplying block width; and block width multiplying block height is smaller than a ninth number, or block width multiplying block height is smaller than or equals to the ninth number. In some embodiments, the first number, the second number, the third number, the fourth number, the fifth number, the sixth number, the seventh number, the eighth number and the ninth number may be pre-defined integer constants.

In some embodiments, the type of the CCP mode may be only allowed for a small block. In some embodiments, the type of the CCP mode may be allowed for a block which is smaller than 4×4, or 8×8, or 16×16, or 32×32. In some embodiments, the type of the CCP mode may be allowed for a small block with samples of which the number of samples are less than 32, 64, or 128. In some embodiments, the type of the CCP mode may be not allowed for 2×N blocks, wherein N is an integer number and is greater than 4, 8 or 16. Alternatively, the type of the CCP mode may be not allowed for N×2 blocks, wherein N is greater than 4, 8 or 16.

In some embodiments, the CCP model may be used in a single tree. In some embodiments, if a collocated luma block is coded with intraTMP mode, a chroma block may be coded with a CCP mode and a CCP model may be generated based on the block vector or the motion vector of an intraTMP coded luma block.

In some embodiments, the CCP model is used in a dual tree. In some embodiments, if a collocated luma block is coded with IBC or intraTMP mode, a chroma block is coded with a CCP mode and a CCP model is generated based on the block vector or the motion vector of an IBC or an intraTMP coded luma block.

In some embodiments, the CCP model may be used in an inter slice. In some embodiments, the inter slice may be a B slice or a P slice.

In some embodiments, the CCP model may be used in an intra slice. In some embodiments, the intra slice may be an I slice.

In some embodiments, a training or reference sample may be prediction sample and/or reconstruction sample in a training or reference area.

In some embodiments, an indication of whether to and/or how to determine a set of training samples for a CCP model generation for a chroma block based on at least one of: a prediction mode of at least one luma sample, a block vector, a motion vector, a reference block identified by the block vector, or a reference block identified by the motion vector may be indicated at one of the followings: sequence level, group of pictures level, picture level, slice level, or tile group level. In some embodiments, an indication of whether to and/or how to determine a set of training samples for a CCP model generation for a chroma block based on at least one of: a prediction mode of at least one luma sample, a block vector, a motion vector, a reference block identified by the block vector, or a reference block identified by the motion vector may be indicated in one of the followings: a sequence header, a picture header, a sequence parameter set (SPS), a video parameter set (VPS), a decoding parameter set (DPS), a decoding capability information (DCI), a picture parameter set (PPS), an adaptation parameter sets (APS), a slice header, or a tile group header. In some embodiments, an indication of whether to and/or how to determine a set of training samples for a CCP model generation for a chroma block based on at least one of: a prediction mode of at least one luma sample, a block vector, a motion vector, a reference block identified by the block vector, or a reference block identified by the motion vector may be included in one of the followings: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 2400 may further comprise: determining, based on coded information of the video unit, whether to and/or how to determine a set of training samples for a CCP model generation for a chroma block based on at least one of: a prediction mode of at least one luma sample, a block vector, a motion vector, a reference block identified by the block vector, or a reference block identified by the motion vector. The coded information may include at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a set of training samples for a cross-component prediction (CCP) model generation for a chroma block based on at least one of: a prediction mode of at least one luma sample, a block vector, a motion vector, a reference block identified by the block vector, or a reference block identified by the motion vector; deriving a CCP model based on the set of training sample; and generating the bitstream based on the CCP model.

According to still further embodiments of the present disclosure, a method for storing bitstream of a video is provided. The method comprises: determining a set of training samples for a cross-component prediction (CCP) model generation for a chroma block based on at least one of: a prediction mode of at least one luma sample, a block vector, a motion vector, a reference block identified by the block vector, or a reference block identified by the motion vector; deriving a CCP model based on the set of training sample; generating the bitstream based on the CCP model; and storing the bitstream in a non-transitory computer-readable recording medium.

FIG. 25 illustrates a flowchart of a method 2500 for video processing in accordance with embodiments of the present disclosure. The method 2500 is implemented during a conversion between a video unit of a video and a bitstream of the video.

At block 2510, for a conversion between a video unit of a video and a bitstream of the video, that a DBV mode is used in at least one of: an inter slice, a single tree, or camera captured video content is determined.

At block 2520, the conversion is performed based on the DBV mode. In some embodiments, the conversion includes encoding the video unit into the bitstream. Alternatively, the conversion includes decoding the video unit from the bitstream.

The method 2500 enables DBV mode not only in intra dual tree slice, which can advantageously improve the coding efficiency and performance compared with the conventional solution.

In some embodiments, DBV mode may be used or allowed in inter slices. In some embodiments, DBV mode may be used for a block in a inter B slice or inter P slice.

In some embodiments, if a luma block is intraTMP coded, a chroma block in an inter slice may be coded with DBV mode. In some embodiments, a syntax element in an inter slice may be signalled to indicate a DBV coded chroma block.

In some embodiments, DBV mode may be used or allowed in single tree. In some embodiments, DBV may be used for a block in a single tree intra slice.

In some embodiments, if a luma block is intraTMP coded, a chroma block in single tree may be coded with DBV mode. In some embodiments, a syntax element in single tree may be signalled to indicate a DBV coded chroma block.

In some embodiments, DBV mode may be used or allowed for camera captured video content. In some embodiments, a block vector or a motion vector of a DBV coded chroma block may be in fractional precision. Alternatively, a block vector or a motion vector of a DBV coded chroma block may be in integer precision.

In some embodiments, in single tree and/or inter slices, a block vector of a DBV coded chroma block may be derived from a luma block vector, and/or in single tree and/or inter slices, a motion vector of a DBV coded chroma block may be derived from a luma motion vector. In some embodiments, the luma block vector or the luma motion vector may be derived from a collocated luma block to the chroma block. In some other embodiments, the luma block vector or the luma motion vector may be derived from a luma block adjacent or non-adjacent to a collocated luma block.

In some embodiments, a first available luma block vector or a first available luma motion vector may be obtained according to a pre-defined checking order and position. In some embodiments, a luma block vector or a luma motion vector may be selected from a plurality of available luma block vectors or a plurality of available luma motion vectors according to a pre-defined rule. In some other embodiments, the pre-defined rule may be a template cost-based rule.

In some embodiments, an offset may be used to adjust a luma block vector or a luma motion vector to calculate the DBV coded chroma block. In some embodiments, to calculate the DBV coded chroma block, downsampleRatio_width and downsampleRatio_height may be downsampling factors dependent on color format.

In some embodiments, to calculate the DBV coded chroma block, chromaBV_hor=lumaBV_hor*downsampleRatio_width+offsetX, where chromaBV_hor represents horizontal of chromaBV, lumaBV_hor represents horizontal of lumaBV, downsampleRatio_width represents width of downsampleRatio, and offsetX represents horizontal of the offset. In some embodiments, to calculate the DBV coded chroma block, chromaBV_ver=lumaBV_ver*downsampleRatio_height+offsetY, wherein chromaBV_ver represents vertical of chromaBV, lumaBV_ver represents vertical of lumaBV, downsampleRatio_height represents height of downsampleRatio, and offsetY represents vertical of the offset.

In some embodiments, offsetX and offsetY may be negative or positive values, where offsetX represents horizontal of the offset, and offsetY represents vertical of the offset. In some embodiments, offsetX and offsetY may be dependent on a reconstruction reorder type of the luma block, where offsetX represents horizontal of the offset, and offsetY represents vertical of the offset.

In some embodiments, the reconstruction reorder type of the luma block may be at least one of: flip type, reconstruction reordered IBC (RRIBC) type, or reconstruction reordered template matching prediction (RRTMP) type.

In some embodiments, an indication of whether to and/or how to determine that a DBV mode is used in at least one of: an inter slice, a single tree, or camera captured video content may be indicated at one of the followings: sequence level, group of pictures level, picture level, slice level, or tile group level. In some embodiments, an indication of whether to and/or how to determine that a DBV mode is used in at least one of: an inter slice, a single tree, or camera captured video content may be indicated in one of the followings: a sequence header, a picture header, a sequence parameter set (SPS), a video parameter set (VPS), a decoding parameter set (DPS), a decoding capability information (DCI), a picture parameter set (PPS), an adaptation parameter sets (APS), a slice header, or a tile group header. In some embodiments, an indication of whether to and/or how to determine that a DBV mode is used in at least one of: an inter slice, a single tree, or camera captured video content may be included in one of the followings: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 2500 further may comprise: determining, based on coded information of the video unit, whether to and/or how to determine that a DBV mode is used in at least one of: an inter slice, a single tree, or camera captured video content. The coded information may include at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: determining, that a DBV mode is used in at least one of: an inter slice, a single tree, or camera captured video content; and generating the bitstream based on the DBV mode.

According to still further embodiments of the present disclosure, a method for storing bitstream of a video is provided. The method comprises: determining, that a DBV mode is used in at least one of: an inter slice, a single tree, or camera captured video content; generating the bitstream based on the DBV mode; and storing the bitstream in a non-transitory computer-readable recording medium.

Implementations of the present disclosure can be described in view of the following clauses, the features of which can be combined in any reasonable manner.

Clause 1. A method for video processing, comprising: determining, for a conversion between a video unit of a video and a bitstream of the video, a set of training samples for a cross-component prediction (CCP) model generation for a chroma block based on at least one of: a prediction mode of at least one luma sample, a block vector, a motion vector, a reference block identified by the block vector, or a reference block identified by the motion vector; deriving a CCP model based on the set of training sample; and performing the conversion based on the CCP model.

Clause 2. The method of clause 1, wherein the at least one luma sample is collocated to a chroma sample of a current chroma block.

Clause 3. The method of clause 2, wherein the chroma sample is located at one or more positions of the current chroma block.

Clause 4. The method of clause 3, wherein the one or more positions of the current chroma block comprise at least one of: center of the current chroma block, top-left of the current chroma block, top-middle of the current chroma block, top-right of the current chroma block, bottom-left of the current chroma block, bottom-middle of the current chroma block, or bottom-right of the current chroma block.

Clause 5. The method of clause 1, wherein the at least one luma sample is adjacent to a collocated luma block of a current chroma block.

Clause 6. The method of clause 1, wherein the at least one luma sample is non-adjacent to a collocated luma block of a current chroma block.

Clause 7. The method of clause 5 or 6, wherein a first available luma block vector or a first available luma motion vector is obtained according to a pre-defined checking order and position.

Clause 8. The method of clause 6, wherein a luma block vector or a motion vector is selected from a plurality of available luma block vectors or a plurality of available luma motion vectors respectively, according to a pre-defined rule.

Clause 9. The method of clause 8, wherein the pre-defined rule is a template cost-based rule.

Clause 10. The method of clause 1, wherein the determination of the set of training samples is dependent on whether the at least one luma sample is coded with intra block copy (IBC) mode.

Clause 11. The method of clause 1, wherein the determination of the set of training samples is dependent on whether the at least one luma sample is coded with intra template matching prediction (intraTMP) mode.

Clause 12. The method of clause 1, wherein the determination of the set of training samples is dependent on whether the at least one luma sample is coded with inter mode.

Clause 13. The method of clause 1, wherein a CCP mode derived based on a block vector or a motion vector is used for a chroma block.

Clause 14. The method of clause 13, wherein at least one of the followings is derived based on the block vector or the motion vector: one or more training samples of a cross-component linear model (CCLM), one or more training samples of a multi-model linear model (MMLM), one or more training samples of a gradient linear model (GLM), one or more training samples of convolutional cross-component model (CCCM), one or more training samples of a gradient linear-convolutional cross-component model (GL-CCCM), one or more training samples of non-downsampled-CCCM, or one or more training samples of cross-component residual model (CCRM) mode.

Clause 15. The method of clause 13, wherein if the CCP mode derived based on the block vector or the motion vector is applied, collocated luma samples of the current chroma block are used as filter input.

Clause 16. The method of clause 13, wherein which type of the CCP mode derived based on the block vector or the motion vector is finally determined for the current chroma block is signalled in the bitstream.

Clause 17. The method of clause 13, wherein which type of the CCP mode derived based on the block vector or the motion vector is finally determined for the current chroma block is derived through a decoder derived approach.

Clause 18. The method of clause 17, wherein the decoder derived approach is a template cost based approach.

Clause 19. The method of clause 1, wherein if the block vector or the motion vector is available for the chroma block, the reference block identified by the block vector or the motion vector is used to derive the CCP model, wherein the block vector guided reference block or the motion vector guided reference block comprises both luma and chroma reference samples.

Clause 20. The method of clause 19, wherein coefficients of the CCP model are derived based on at least one of: the block vector identified reference block, or the motion vector identified reference block.

Clause 21. The method of clause 19, wherein a threshold to separate samples into more than one category for a multi-model CCP mode is derived based on the block vector identified reference block or the motion vector identified reference block.

Clause 22. The method of clause 21, wherein an average of luma samples values in the block vector identified reference block or the motion vector identified reference block is used as the threshold to separable luma and/or chroma samples in a training area into two categories.

Clause 23. The method of clause 21, wherein an average of luma samples values in the block vector identified reference block or the motion vector identified reference block is used as the threshold to separable luma and/or chroma samples in a collocated luma block into two categories.

Clause 24. The method of clause 19, wherein in dual tree, the block vector or the motion vector is derived based on a luma sample which derived based on location of the current chroma block.

Clause 25. The method of clause 24, wherein the luma sample is within an area that covers a collocated luma block of the current chroma block.

Clause 26. The method of clause 24, wherein the luma sample is adjacent or non-adjacent to an area that covers a collocated luma block of the current chroma block.

Clause 27. The method of clause 24, wherein the luma sample is IBC or intraTMP coded.

Clause 28. The method of clause 19, wherein in single tree, the block vector or the motion vector is derived based on a collocated luma block of the current chroma block.

Clause 29. The method of clause 28, wherein the collocated luma block is intraTMP coded.

Clause 30. The method of clause 28, wherein the collocated luma block is IBC coded.

Clause 31. The method of clause 19, wherein the block vector or the motion vector is derived based on a direct block vector (DBV) chroma mode or a direct motion vector chroma mode, respectively.

Clause 32. The method of clause 31, wherein based on the block vector or the motion vector, a reference chroma block and collocated luma block of the reference chroma block are identified.

Clause 33. The method of clause 32, wherein a sample of at least one of: the reference chroma block or the collocated luma block of the reference chroma block is used as a training sample for a CCP model calculation.

Clause 34. The method of clause 19, wherein a variant of the block vector or the motion vector is used to identify a reference block for the CCP model generation.

Clause 35. The method of clause 34, wherein an offset is added to the block vector or the motion vector.

Clause 36. The method of clause 34, wherein the block vector or the motion vector is adjusted by a scaling factor.

Clause 37. The method of clause 19, wherein the block vector or the motion vector guided CCP prediction is derived based on a reconstruction reordered IBC or intraTMP.

Clause 38. The method of clause 37, wherein at least one of: a reference region or a reconstruction of the block vector or the motion vector guided CCP chroma block is flipped based on a flip type of a reconstruction reordered IBC or intraTMP of the luma component; and/or wherein at least one of: a reference region or a reconstruction of the block vector or the motion vector guided CCP chroma block is reordered based on a flip type of a reconstruction reordered IBC or intraTMP of the luma component.

Clause 39. The method of clause 1, wherein a restriction is applied to a block vector or a motion vector for the CCP model generation.

Clause 40. The method of clause 39, wherein a reference block pointed by the block vector or the motion vector does not exceed a current coding tree unit (CTU) row restriction; or wherein a reference block identified by the block vector or the motion vector does not exceed a current coding tree unit (CTU) row restriction.

Clause 41. The method of clause 39, wherein a reference block pointed by the block vector or the motion vector is required to not above a predetermined number of CTUs away from the current CTU; or wherein a reference block identified by the block vector or the motion vector is required to not above a predetermined number of CTUs away from the current CTU.

Clause 42. The method of clause 41, wherein the predetermined number equals to one of: 0, 1, 2, 3, or 4.

Clause 43. The method of clause 39, wherein a reference block pointed by the block vector or the motion vector is required to inside a collocated CTU plus a predetermined number of columns on the right; or wherein a reference block identified by the block vector or the motion vector is required to inside a collocated CTU plus a predetermined number of columns on the right.

Clause 44. The method of clause 43, wherein the predetermined number equals to 3.

Clause 45. The method of clause 39, wherein if a reference block pointed or identified by the block vector or the motion vector breaks the pre-defined restriction, a CCP mode is not used or allowed to a current chroma block.

Clause 46. The method of clause 45, wherein a syntax element related to the CCP mode is not signalled.

Clause 47. The method of clause 45, wherein a signalling of the CCP mode is dependent on a condition of a restriction.

Clause 48. The method of clause 39, wherein if a reference block pointed or identified by the block vector or the motion vector breaks the pre-defined restriction, the reference block is re-positioned to a valid area.

Clause 49. The method of clause 39, wherein if a reference block pointed or identified by the block vector or the motion vector breaks the pre-defined restriction, an unavailable sample of the reference block is filled with other values.

Clause 50. The method of clause 39, wherein if partial samples of a reference block are not valid, the unavailable sample of the reference block is padded.

Clause 51. The method of clause 50, wherein partial samples of a reference block are not valid comprises at least one of: partial samples of a reference block are not decoded; or partial samples of a reference block are already decoded but out of a restricted area.

Clause 52. The method of clause 50, wherein the unavailable sample of the reference block is padded based on available samples.

Clause 53. The method of clause 50, wherein a threshold is used to activate the padding process.

Clause 54. The method of clause 53, wherein if less than a proportion of samples of samples in a whole block are not available, the padding process is used.

Clause 55. The method of clause 54, wherein the proportion equals to ¼, ½, or ¾.

Clause 56. The method of clause 1, wherein a non-downsampled luma sample is used for a block vector or a motion vector guided CCP mode for the chroma block.

Clause 57. The method of clause 56, wherein coefficients of the CCP model of a block vector or a motion vector guided CCP model are generated by using non-downsampled luma samples of the reference area as training samples.

Clause 58. The method of clause 56, wherein a block vector or a motion vector guided CCP model is applied to a chroma block, wherein a chroma sample of the current chroma block is generated based on the non-downsampled luma sample of a collocated luma block.

Clause 59. The method of clause 1, wherein at least one of: sample value, gradient, or location information is used for determining a filter model for a block vector or a motion vector guided CCP model.

Clause 60. The method of clause 59, wherein at least one of a first number-tap filter is used for a CCP model, which comprises a second number of sample terms, a third number of gradients terms, a fourth number of location or positional terms, a fifth number of non-linear terms, a sixth number of bias terms.

Clause 61. The method of clause 60, wherein the second number equals to one of: 0, 1, 2, 5, or 6.

Clause 62. The method of clause 60, wherein the third number equals to one of: 0, 1, 2, or 4.

Clause 63. The method of clause 60, wherein the fourth number equals to one of: 0, 1, 2, or 4.

Clause 64. The method of clause 60, wherein the fifth number equals to one of: 0, 1, 2, or 4.

Clause 65. The method of clause 60, wherein the sixth number equals to one of: 0 or 1.

Clause 66. The method of clause 60, wherein the first number equals to a sum of the second number, the third number, the fourth number, the fifth number and the sixth number.

Clause 67. The method of clause 60, wherein the sample term is calculated based on luma sample values.

Clause 68. The method of clause 60, wherein the gradient term is calculated based on a plurality of sample adjacent to a luma sample.

Clause 69. The method of clause 60, wherein the location or positional term is calculated based on horizontal and/or vertical coordinates of a luma sample, wherein the coordinate is relative to top-left position of a reference area.

Clause 70. The method of clause 60, wherein the non-linear term is a square of a value.

Clause 71. The method of clause 70, wherein the square of a value is a bit-depth related mid value or a luma value.

Clause 72. The method of clause 71, wherein the bit-depth related mid value is 512 or 256.

Clause 73. The method of clause 60, wherein the non-linear term is a square of a gradient value based on a gradient term.

Clause 74. The method of clause 60, wherein an offset is subtracted from a term of the first number-tap filter.

Clause 75. The method of clause 74, wherein the offset is derived based on a pre-defined rule.

Clause 76. The method of clause 75, wherein the pre-defined rule is a value of a top-left training sample in a training area, or an average or mid value of a plurality of samples in the training area.

Clause 77. The method of clause 60, wherein a coefficient of the first number-tap filter is determined by a gaussian elimination solver.

Clause 78. The method of clause 60, wherein a coefficient of the first number-tap filter is determined by an LDL decomposition approach.

Clause 79. The method of clause 60, wherein a coefficient of the first number-tap filter is determined by linear regression.

Clause 80. The method of clause 60, wherein a coefficient of the first number-tap filter is determined by linear equation.

Clause 81. The method of clause 59, wherein a plurality of filters are used, and a final prediction is derived based on fusing a plurality of filtered values together.

Clause 82. The method of clause 81, wherein weights to fuse the plurality of filtered values are determined by a gaussian elimination solver.

Clause 83. The method of clause 81, wherein weights to fuse the plurality of filtered values are determined by an LDL decomposition approach.

Clause 84. The method of clause 1, wherein a filter output is clipped to a value.

Clause 85. The method of clause 84, wherein the filter output is clipped based on reconstruction values in a training area.

Clause 86. The method of clause 85, wherein the training area is derived based on a block vector or a motion vector.

Clause 87. The method of clause 85, wherein the training area is adjacent to a current block.

Clause 88. The method of clause 85, wherein the training area is a reference region of a current block.

Clause 89. The method of clause 85, wherein the filter output is clipped within minimum and maximum of reconstructed luma samples values in a training area; or wherein the filter output is clipped within minimum and maximum of predicted luma samples values in a training area.

Clause 90. The method of clause 84, wherein the filter output is clipped based on reconstruction values in the collocated luma block of a current chroma block; or wherein the filter output is clipped based on predicted values in the collocated luma block of a current chroma block.

Clause 91. The method of clause 90, wherein the filter output is clipped within minimum and maximum of the current block luma reconstructed values; or wherein the filter output is clipped within minimum and maximum of the current block luma predicted values.

Clause 92. The method of clause 84, wherein the filter output is ignored, discarded, or not used if the value is outside of a valid range.

Clause 93. The method of clause 1, wherein whether to use block vector guided, motion vector guided, non-motion-vector guided, or non-block-vector guided reference samples for a CCP model generation for a chroma block, is determined based on template cost.

Clause 94. The method of clause 93, wherein the determination of whether to use block vector guided, motion vector guided, non-motion-vector guided, or non-block-vector guided reference samples is made at both decoder side and encoder side.

Clause 95. The method of clause 93, wherein the determination is made at both decoder side and encoder side without signalling.

Clause 96. The method of clause 93, wherein there is no need to signal a syntax element to indicate whether to use block vector guided, motion vector guided, non-motion-vector guided, or non-block-vector guided reference samples for a CCP model generation.

Clause 97. The method of clause 93, wherein a first CCP model is generated by using the non-block-vector guided reference samples as training samples, and the first CCP model is applied to template samples, a first template cost is then calculated by comparing difference between model-estimated prediction values of template samples and true reconstruction values of template samples; a second CCP model is generated by using the block-vector guided reference samples as training samples, and the second CCP model is applied to template samples, a second template cost is then calculated by comparing difference between model-estimated prediction values of template samples and true reconstruction values of template samples; and by comparing the first template cost and the second template cost, a final set of training samples with less template cost are determined as the final training samples and corresponding CCP model of the final training samples is used as the final CCP model for the current chroma block coding.

Clause 98. The method of clause 93, wherein the non-block-vector guided reference samples are a first number of rows and a second number of columns of neighboring chroma samples adjacent to the current chroma block.

Clause 99. The method of clause 93, wherein the first number equals to 2, 4, or 6; and the second number equals to 2, 4, or 6.

Clause 100. The method of clause 98, wherein the non-block-vector guided reference samples are a third number multiplying the first number of rows and the third number multiplying the second number of columns of neighboring luma samples adjacent to a collocated luma block, wherein the third number indicates a scaling factor dependent on chroma format.

Clause 101. The method of clause 100, wherein the third number equals to 2 for 4:2:0 chroma format.

Clause 102. The method of clause 100, wherein the neighboring luma sample is non-downsampled.

Clause 103. The method of clause 98, wherein the non-block-vector guided reference samples are the first number of rows and the second number of columns of neighboring luma samples adjacent to a collocated luma block.

Clause 104. The method of clause 103, wherein the neighboring luma sample is downsampled based on a chroma format.

Clause 105. The method of clause 93, wherein the block-vector guided reference samples are luma and chroma samples inside a reference block which is identified by the block vector or the motion vector.

Clause 106. The method of clause 1, wherein usage of a block-vector guided CCP mode is singled in bitstream.

Clause 107. The method of clause 106, wherein the usage of a block-vector guided CCP mode is signalled based on an availability of an IBC coded luma block.

Clause 108. The method of clause 106, wherein the usage of a block-vector guided CCP mode is signalled based on an availability of an intraTMP coded luma block.

Clause 109. The method of clause 106, wherein the usage of a block-vector guided CCP mode is signalled based on an availability of an inter coded luma block.

Clause 110. The method of clause 106, wherein whether the block-vector guided CCP mode is used for a chroma block is signalled in an intra chroma mode syntax structure.

Clause 111. The method of clause 106, wherein whether the block-vector guided CCP mode is used for a chroma block is signalled in an IBC mode syntax structure.

Clause 112. The method of clause 106, wherein whether the block-vector guided CCP mode is used for a chroma block is signalled in an inter mode syntax structure.

Clause 113. The method of clause 106, wherein whether the block-vector guided CCP mode is used for a chroma block is signalled conditioned on usage of a CCCM mode.

Clause 114. The method of clause 113, wherein the CCCM mode comprises at least one of: CCCM, GL-CCCM, or non-downsample-CCCM flag.

Clause 115. The method of clause 106, wherein whether the block-vector guided CCP mode is used for a chroma block is signalled conditioned on usage of a GLM mode.

Clause 116. The method of clause 115, wherein the GLM mode comprises at least one of: GLM flag or index.

Clause 117. The method of clause 106, wherein whether the block-vector guided CCP mode is used for a chroma block is signalled conditioned on a LM mode.

Clause 118. The method of clause 117, wherein the LM mode comprises at least one of: single model, multiple model, top-left mode, top only mode, or left only mode.

Clause 119. The method of clause 1, wherein parameters of the CCP model of the video unit which is block-vector guided CCP coded are stored in a buffer and used for coding of a future block.

Clause 120. The method of clause 119, wherein the parameters of the CCP model of the video unit comprise at least one of: CCP mode type, model coefficients, whether the CCP model is single model or multiple models, or threshold to separate samples into multiple models.

Clause 121. The method of clause 120, wherein the parameters of the CCP model of the video unit comprise at least one of: coding unit (CU), prediction unit (PU), color component, Cb, or Cr.

Clause 122. The method of clause 119, wherein the parameters of the CCP model of a block-vector guided CCP coded block are stored in a local buffer for the coding of a future block in a current picture.

Clause 123. The method of clause 119, wherein the parameters of the CCP model of a block-vector guided CCP coded block are stored in a temporal or picture buffer for the coding of a future block in a future decoded picture.

Clause 124. The method of clause 123, wherein the parameters of the CCP model of a block-vector guided CCP coded block are stored associated with motion and mode information of a video unit.

Clause 125. The method of clause 119, wherein a future block inherits the CCP model parameters from a block-vector guided CCP coded neighbor block.

Clause 126. The method of clause 125, wherein the future block is coded by a non-local CCP mode.

Clause 127. The method of clause 125, wherein the future block is coded by a CCP merge mode.

Clause 128. The method of clause 127, wherein the CCP merge is cross-component merge (CCmerge).

Clause 129. The method of clause 1, wherein a final prediction of a block-vector guided CCP coded block is generated based on a plurality of prediction candidates from different block-vector guided CCP models.

Clause 130. The method of clause 129, wherein a plurality of block-vector guided CCP model predictions are fused together.

Clause 131. The method of clause 129, wherein weights or coefficients of different fused CCP models are determined based on a Gaussian elimination approach.

Clause 132. The method of clause 129, wherein weights or coefficients of different fused CCP models are determined based on an LDL decomposition approach.

Clause 133. The method of clause 129, wherein a bias CCP model is involved for a fusion.

Clause 134. The method of clause 129, wherein a non-linear CCP model is involved for a fusion.

Clause 135. The method of clause 1, wherein the CCP mode is one of: CCLM, a variant of CCLM, MMLM, a variant of MMLM, CCCM, a variant of CCCM, GLM, a variant of GLM, CCRM, a variant of CCRM, a cross-component prediction that uses information in one channel or one component to predict information in another channel or another component, and/or a filter-based prediction wherein the filter coefficients are determined based on correlation between prediction and/or reconstruction information.

Clause 136. The method of clause 1, wherein a block restriction is applied to limit an application of a type of a CCP mode.

Clause 137. The method of clause 136, wherein a CCP mode is only allowed to be used for a block size satisfying a pre-defined rule.

Clause 138. The method of clause 136, wherein a syntax element is signalled if the CCP mode is applicable.

Clause 139. The method of clause 136, wherein if the CCP mode is not allowed to be used, a syntax element is inferred to a value indicating the CCP mode is not used for the block.

Clause 140. The method of clause 136, wherein at least one of the following block restrictions are applied to the CCP mode: block width is smaller than a first number, or block width is smaller than or equals to the first number; block height is smaller than a second number, or block height is smaller than or equals to the second number; minimum of block width and block height is bigger than a third number, or the minimum one of block width and block height is bigger than or equals to the third number; maximum of block width and block height is smaller than a fourth number, or the maximum of block width and block height is smaller than or equals to the fourth number; block width is smaller than a fifth number multiplying block height, or block width is smaller than or equals to the fifth number multiplying block height; block width is bigger than a sixth number multiplying block height, or block width is bigger than or equals to the sixth number multiplying block height; block height is smaller than a seventh number multiplying block width, or block height is smaller than or equals to a seventh number multiplying block width; block height is bigger than an eighth number multiplying block width, or block height is bigger than or equals to the eighth number multiplying block width; and block width multiplying block height is smaller than a ninth number, or block width multiplying block height is smaller than or equals to the ninth number.

Clause 141. The method of clause 140, wherein the first number, the second number, the third number, the fourth number, the fifth number, the sixth number, the seventh number, the eighth number and the ninth number are pre-defined integer constants.

Clause 142. The method of clause 136, wherein the type of the CCP mode is only allowed for a small block.

Clause 143. The method of clause 142, wherein the type of the CCP mode is allowed for a block which is smaller than 4×4, or 8×8, or 16×16, or 32×32.

Clause 144. The method of clause 142, wherein the type of the CCP mode is allowed for a small block with samples of which the number of samples are less than 32, 64, or 128.

Clause 145. The method of clause 142, wherein the type of the CCP mode is not allowed for 2×N blocks, wherein N is an integer number and is greater than 4, 8 or 16.

Clause 146. The method of clause 142, wherein the type of the CCP mode is not allowed for N×2 blocks, wherein N is greater than 4, 8 or 16.

Clause 147. The method of clause 1, wherein determining a set of training samples for a CCP model generation for a chroma block is used in a single tree.

Clause 148. The method of clause 147, wherein if a collocated luma block is coded with intraTMP mode, a chroma block is coded with a CCP mode and a CCP model is generated based on a block vector of an intraTMP coded luma block.

Clause 149. The method of clause 147, wherein if a collocated luma block is coded with intraTMP mode, a chroma block is coded with a CCP mode and a CCP model is generated based on a motion vector of an intraTMP coded luma block.

Clause 150. The method of clause 1, wherein the CCP model is used in a dual tree.

Clause 151. The method of clause 150, wherein if a collocated luma block is coded with IBC or intraTMP mode, a chroma block is coded with a CCP mode and a CCP model is generated based on the block vector or the motion vector of an IBC or an intraTMP coded luma block.

Clause 152. The method of clause 1, wherein the CCP model is used in an inter slice.

Clause 153. The method of clause 152, wherein the inter slice is a B slice or a P slice.

Clause 154. The method of clause 1, wherein the CCP model is used in an intra slice.

Clause 155. The method of clause 154, wherein the intra slice is an I slice.

Clause 156. The method of clause 1, wherein a training or reference sample are prediction sample and/or reconstruction sample in a training or reference area.

Clause 157. The method of any of clauses 1-156, wherein an indication of whether to and/or how to determine a set of training samples for a CCP model generation for a chroma block based on at least one of: a prediction mode of at least one luma sample, a block vector, a motion vector, a reference block identified by the block vector, or a reference block identified by the motion vector is indicated at one of the followings: sequence level, group of pictures level, picture level, slice level, or tile group level.

Clause 158. The method of any of clauses 1-156, wherein an indication of whether to and/or how to determine a set of training samples for a CCP model generation for a chroma block based on at least one of: a prediction mode of at least one luma sample, a block vector, a motion vector, a reference block identified by the block vector, or a reference block identified by the motion vector is indicated in one of the followings: a sequence header, a picture header, a sequence parameter set (SPS), a video parameter set (VPS), a decoding parameter set (DPS), a decoding capability information (DCI), a picture parameter set (PPS), an adaptation parameter sets (APS), a slice header, or a tile group header.

Clause 159. The method of any of clauses 1-156, wherein an indication of whether to and/or how to determine a set of training samples for a CCP model generation for a chroma block based on at least one of: a prediction mode of at least one luma sample, a block vector, a motion vector, a reference block identified by the block vector, or a reference block identified by the motion vector is included in one of the followings: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 160. The method of any of clauses 1-156, determining, based on coded information of the video unit, whether to and/or how to determine a set of training samples for a CCP model generation for a chroma block based on at least one of: a prediction mode of at least one luma sample, a block vector, a motion vector, a reference block identified by the block vector, or a reference block identified by the motion vector, the coded information including at least one of: a block size, a colour format, a single and/or dual tree partitioning, a colour component, a slice type, or a picture type.

Clause 161. A method for video processing, comprising: determining, for a conversion between a video unit of a video and a bitstream of the video, that a DBV mode is used in at least one of: an inter slice, a single tree, or camera captured video content; and performing the conversion based on the DBV mode.

Clause 162. The method of clause 161, wherein the DBV mode is used or allowed in inter slices.

Clause 163. The method of clause 162, wherein the DBV mode is used for a block in a inter B slice or inter P slice.

Clause 164. The method of clause 162, wherein if a luma block is intraTMP coded, a chroma block in an inter slice is coded with the DBV mode.

Clause 165. The method of clause 162, wherein a syntax element in an inter slice is signalled to indicate a DBV coded chroma block.

Clause 166. The method of clause 161, wherein the DBV mode is used or allowed in single tree.

Clause 167. The method of clause 166, wherein DBV is used for a block in a single tree intra slice.

Clause 168. The method of clause 166, wherein if a luma block is intraTMP coded, a chroma block in single tree is coded with the DBV mode.

Clause 169. The method of clause 166, wherein a syntax element in single tree is signalled to indicate a DBV coded chroma block.

Clause 170. The method of clause 161, wherein DBV mode is used or allowed for camera captured video content.

Clause 171. The method of clause 161, wherein a block vector of a DBV coded chroma block and/or a motion vector of a DBV coded chroma block is in fractional precision.

Clause 172. The method of clause 161, wherein a block vector of a DBV coded chroma block and/or a motion vector of a DBV coded chroma block is in integer precision.

Clause 173. The method of clause 161, wherein in single tree and/or inter slices, a block vector of a DBV coded chroma block is derived from a luma block vector, and/or in single tree and/or inter slices, a motion vector of a DBV coded chroma block is derived from a luma motion vector.

Clause 174. The method of clause 173, wherein the luma block vector or the luma motion vector is derived from a collocated luma block to the chroma block.

Clause 175. The method of clause 173, wherein the luma block vector or the luma motion vector is derived from a luma block adjacent or non-adjacent to a collocated luma block.

Clause 176. The method of clause 175, wherein a first available luma block vector or a first available luma motion vector is obtained according to a pre-defined checking order and position.

Clause 177. The method of clause 175, wherein a luma block vector or a luma motion vector is selected from a plurality of available luma block vectors or a plurality of available luma motion vectors according to a pre-defined rule.

Clause 178. The method of clause 177, wherein the pre-defined rule is a template cost-based rule.

Clause 179. The method of clause 173, wherein an offset is used to adjust a luma block vector or a luma motion vector to calculate the DBV coded chroma block.

Clause 180. The method of clause 179, wherein to calculate the DBV coded chroma block, downsampleRatio_width and downsampleRatio_height are downsampling factors dependent on color format.

Clause 181. The method of clause 179, wherein to calculate the DBV coded chroma block, chromaBV_hor=lumaBV_hor*downsampleRatio_width+offsetX, wherein chromaBV_hor represents horizontal of chromaBV, lumaBV_hor represents horizontal of lumaBV, downsampleRatio_width represents width of downsampleRatio, and offsetX represents horizontal of the offset.

Clause 182. The method of clause 179, wherein to calculate the DBV coded chroma block, chromaBV_ver=lumaBV_ver*downsampleRatio_height+offsetY, wherein chromaBV_ver represents vertical of chromaBV, lumaBV_ver represents vertical of lumaBV, downsampleRatio_height represents height of downsampleRatio, and offsetY represents vertical of the offset.

Clause 183. The method of clause 179, offsetX and offsetY are negative or positive values, wherein offsetX represents horizontal of the offset, and offsetY represents vertical of the offset.

Clause 184. The method of clause 179, offsetX and offsetY are dependent on a reconstruction reorder type of the luma block, wherein offsetX represents horizontal of the offset, and offsetY represents vertical of the offset.

Clause 185. The method of clause 179, the reconstruction reorder type of the luma block is at least one of: flip type, RRIBC type, or RRTMP type.

Clause 186. The method of any of clauses 161-185, wherein an indication of whether to and/or how to determine that a DBV mode is used in at least one of: an inter slice, a single tree, or camera captured video content is indicated at one of the followings: sequence level, group of pictures level, picture level, slice level, or tile group level.

Clause 187. The method of any of clauses 161-185, wherein an indication of whether to and/or how to determine that a DBV mode is used in at least one of: an inter slice, a single tree, or camera captured video content is indicated in one of the followings: a sequence header, a picture header, a sequence parameter set (SPS), a video parameter set (VPS), a decoding parameter set (DPS), a decoding capability information (DCI), a picture parameter set (PPS), an adaptation parameter sets (APS), a slice header, or a tile group header.

Clause 188. The method of any of clauses 161-185, wherein an indication of whether to and/or how to determine that a DBV mode is used in at least one of: an inter slice, a single tree, or camera captured video content is included in one of the followings: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 189. The method of any of clauses 161-185, further comprising: determining, based on coded information of the video unit, whether to and/or how to determine that a DBV mode is used in at least one of: an inter slice, a single tree, or camera captured video content, the coded information including at least one of: a block size, a colour format, a single and/or dual tree partitioning, a colour component, a slice type, or a picture type.

Clause 190. The method of any of clauses 1-189, wherein the conversion includes encoding the video unit into the bitstream.

Clause 191. The method of any of clauses 1-189, wherein the conversion includes decoding the video unit from the bitstream.

Clause 192. An apparatus for video processing comprising a processor and a non-transitory memory with instructions thereon, wherein the instructions upon execution by the processor, cause the processor to perform a method in accordance with any of clauses 1-191.

Clause 193. A non-transitory computer-readable storage medium storing instructions that cause a processor to perform a method in accordance with any of clauses 1-191.

Clause 194. A non-transitory computer-readable recording medium storing a bitstream of a video which is generated by a method performed by an apparatus for video processing, wherein the method comprises: determining a set of training samples for a cross-component prediction (CCP) model generation for a chroma block based on at least one of: a prediction mode of at least one luma sample, a block vector, a motion vector, a reference block identified by the block vector, or a reference block identified by the motion vector; deriving a CCP model based on the set of training sample; and generating the bitstream based on the CCP model.

Clause 195. A method for storing a bitstream of a video, comprising: determining a set of training samples for a cross-component prediction (CCP) model generation for a chroma block based on at least one of: a prediction mode of at least one luma sample, a block vector, a motion vector, a reference block identified by the block vector, or a reference block identified by the motion vector; generating the bitstream based on the CCP model; and storing the bitstream in a non-transitory computer-readable recording medium.

Clause 196. A non-transitory computer-readable recording medium storing a bitstream of a video which is generated by a method performed by an apparatus for video processing, wherein the method comprises: determining, that a DBV mode is used in at least one of: an inter slice, a single tree, or camera captured video content; and generating the bitstream based on the DBV mode.

Clause 197. A method for storing a bitstream of a video, comprising: determining, that a DBV mode is used in at least one of: an inter slice, a single tree, or camera captured video content; generating the bitstream based on the DBV mode; and storing the bitstream in a non-transitory computer-readable recording medium.

### Example Device

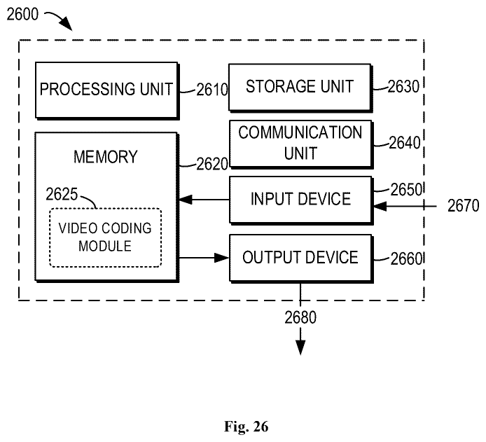

FIG. 26 illustrates a block diagram of a computing device 2600 in which various embodiments of the present disclosure can be implemented. The computing device 2600 may be implemented as or included in the source device 110 (or the video encoder 114 or 200) or the destination device 120 (or the video decoder 124 or 300).

It would be appreciated that the computing device 2600 shown in FIG. 26 is merely for purpose of illustration, without suggesting any limitation to the functions and scopes of the embodiments of the present disclosure in any manner.

As shown in FIG. 26, the computing device 2600 includes a general-purpose computing device 2600. The computing device 2600 may at least comprise one or more processors or processing units 2610, a memory 2620, a storage unit 2630, one or more communication units 2640, one or more input devices 2650, and one or more output devices 2660.

In some embodiments, the computing device 2600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2600 can support any type of interface to a user (such as “wearable” circuitry and the like).

The processing unit 2610 may be a physical or virtual processor and can implement various processes based on programs stored in the memory 2620. In a multi-processor system, multiple processing units execute computer executable instructions in parallel so as to improve the parallel processing capability of the computing device 2600. The processing unit 2610 may also be referred to as a central processing unit (CPU), a microprocessor, a controller or a microcontroller.

The computing device 2600 typically includes various computer storage medium. Such medium can be any medium accessible by the computing device 2600, including, but not limited to, volatile and non-volatile medium, or detachable and non-detachable medium. The memory 2620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2630 may be any detachable or non-detachable medium and may include a machine-readable medium such as a memory, flash memory drive, magnetic disk or another other media, which can be used for storing information and/or data and can be accessed in the computing device 2600.

The computing device 2600 may further include additional detachable/non-detachable, volatile/non-volatile memory medium. Although not shown in FIG. 26, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2640 communicates with a further computing device via the communication medium. In addition, the functions of the components in the computing device 2600 can be implemented by a single computing cluster or multiple computing machines that can communicate via communication connections. Therefore, the computing device 2600 can operate in a networked environment using a logical connection with one or more other servers, networked personal computers (PCs) or further general network nodes.

The input device 2650 may be one or more of a variety of input devices, such as a mouse, keyboard, tracking ball, voice-input device, and the like. The output device 2660 may be one or more of a variety of output devices, such as a display, loudspeaker, printer, and the like. By means of the communication unit 2640, the computing device 2600 can further communicate with one or more external devices (not shown) such as the storage devices and display device, with one or more devices enabling the user to interact with the computing device 2600, or any devices (such as a network card, a modem and the like) enabling the computing device 2600 to communicate with one or more other computing devices, if required. Such communication can be performed via input/output (I/O) interfaces (not shown).

In some embodiments, instead of being integrated in a single device, some or all components of the computing device 2600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2600 may be used to implement video encoding/decoding in embodiments of the present disclosure. The memory 2620 may include one or more video coding modules 2625 having one or more program instructions. These modules are accessible and executable by the processing unit 2610 to perform the functionalities of the various embodiments described herein.

In the example embodiments of performing video encoding, the input device 2650 may receive video data as an input 2670 to be encoded. The video data may be processed, for example, by the video coding module 2625, to generate an encoded bitstream. The encoded bitstream may be provided via the output device 2660 as an output 2680.

In the example embodiments of performing video decoding, the input device 2650 may receive an encoded bitstream as the input 2670. The encoded bitstream may be processed, for example, by the video coding module 2625, to generate decoded video data. The decoded video data may be provided via the output device 2660 as the output 2680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a video unit of a video and a bitstream of the video, a set of training samples for a cross-component prediction (CCP) model generation for a chroma block based on at least one of: a prediction mode of at least one luma sample, a block vector, a motion vector, a reference block identified by the block vector, or a reference block identified by the motion vector;
deriving a CCP model based on the set of training sample; and
performing the conversion based on the CCP model.

2. The method of claim 1, wherein a restriction is applied to a block vector or a motion vector for the CCP model generation.

3. The method of claim 2, wherein a reference block pointed by the block vector or the motion vector does not exceed a current coding tree unit (CTU) row restriction; or
wherein a reference block identified by the block vector or the motion vector does not exceed a current coding tree unit (CTU) row restriction, and/or
wherein a reference block pointed by the block vector or the motion vector is required to not above a predetermined number of CTUs away from the current CTU; or
wherein a reference block identified by the block vector or the motion vector is required to not above a predetermined number of CTUs away from the current CTU, and/or
wherein a reference block pointed by the block vector or the motion vector is required to inside a collocated CTU plus a predetermined number of columns on the right; or
wherein a reference block identified by the block vector or the motion vector is required to inside a collocated CTU plus a predetermined number of columns on the right.

4. The method of claim 2, wherein if a reference block pointed or identified by the block vector or the motion vector breaks the pre-defined restriction, a CCP mode is not used or allowed to a current chroma block, or
wherein if a reference block pointed or identified by the block vector or the motion vector breaks the pre-defined restriction, the reference block is re-positioned to a valid area, or
wherein if a reference block pointed or identified by the block vector or the motion vector breaks the pre-defined restriction, an unavailable sample of the reference block is filled with other values.

5. The method of claim 2, wherein if partial samples of a reference block are not valid, the unavailable sample of the reference block is padded.

6. The method of claim 5, wherein partial samples of a reference block are not valid comprises at least one of:
partial samples of a reference block are not decoded; or
partial samples of a reference block are already decoded but out of a restricted area, or
wherein the unavailable sample of the reference block is padded based on available samples, or
wherein a threshold is used to activate the padding process.

7. The method of claim 1, wherein parameters of the CCP model of the video unit which is block-vector guided CCP coded are stored in a buffer and used for coding of a future block.

8. The method of claim 7, wherein the parameters of the CCP model of the video unit comprise at least one of: CCP mode type, model coefficients, whether the CCP model is single model or multiple models, or threshold to separate samples into multiple models.

9. The method of claim 8, wherein the parameters of the CCP model of the video unit comprise at least one of: coding unit (CU), prediction unit (PU), color component, Cb, or Cr.

10. The method of claim 7, wherein the parameters of the CCP model of a block-vector guided CCP coded block are stored in a local buffer for the coding of a future block in a current picture, or
wherein the parameters of the CCP model of a block-vector guided CCP coded block are stored in a temporal or picture buffer for the coding of a future block in a future decoded picture.

11. The method of claim 10, wherein the parameters of the CCP model of a block-vector guided CCP coded block are stored associated with motion and mode information of a video unit.

12. The method of claim 7, wherein a future block inherits the CCP model parameters from a block-vector guided CCP coded neighbor block.

13. The method of claim 12, wherein the future block is coded by a non-local CCP mode, or
wherein the future block is coded by a CCP merge mode.

14. The method of claim 13, wherein the CCP merge is cross-component merge (CCmerge).

15. The method of claim 1, wherein the CCP model is used in a dual tree.

16. The method of claim 15, wherein if a collocated luma block is coded with IBC or intraTMP mode, a chroma block is coded with a CCP mode and a CCP model is generated based on the block vector or the motion vector of an IBC or an intraTMP coded luma block.

17. The method of claim 1, wherein the conversion includes encoding the video unit into the bitstream, and/or
wherein the conversion includes decoding the video unit from the bitstream.

18. An apparatus for video processing comprising a processor and a non-transitory memory with instructions thereon, wherein the instructions upon execution by the processor, cause the processor to perform acts comprising:
determining, for a conversion between a video unit of a video and a bitstream of the video, a set of training samples for a cross-component prediction (CCP) model generation for a chroma block based on at least one of: a prediction mode of at least one luma sample, a block vector, a motion vector, a reference block identified by the block vector, or a reference block identified by the motion vector;
deriving a CCP model based on the set of training sample; and
performing the conversion based on the CCP model.

19. A non-transitory computer-readable storage medium storing instructions that cause a processor to perform acts comprising:
determining, for a conversion between a video unit of a video and a bitstream of the video, a set of training samples for a cross-component prediction (CCP) model generation for a chroma block based on at least one of: a prediction mode of at least one luma sample, a block vector, a motion vector, a reference block identified by the block vector, or a reference block identified by the motion vector;
deriving a CCP model based on the set of training sample; and
performing the conversion based on the CCP model.

20. A non-transitory computer-readable recording medium storing a bitstream of a video which is generated by a method performed by a video processing apparatus, wherein the method comprises:
determining a set of training samples for a cross-component prediction (CCP) model generation for a chroma block based on at least one of: a prediction mode of at least one luma sample, a block vector, a motion vector, a reference block identified by the block vector, or a reference block identified by the motion vector;
deriving a CCP model based on the set of training sample; and
generating the bitstream based on the CCP model.
